(19) United States
(12) Patent Application Publication
(10) Pub. No.: US 2026/0122091 A1
(43) Pub. Date: Apr. 30, 2026

(54) Router Security Using Large Language Models

(71) Applicants: Drexel University, Philadelphia, PA (US); President and Fellows of Harvard College, Cambridge, MA (US)

(72) Inventors: John Michael Carter, Audobon, NJ (US); Spiros Mancoridis, Philadelphia, PA (US); Pavlos Protopapas, Sommerville, MA (US); Brian Mitchell, Newtown Square, PA (US)

(73) Assignees: Drexel University, Philadelphia, PA (US); President and Fellows of Harvard College, Cambridge, MA (US)

(21) Appl. No.: 19/367,411

(22) Filed: Oct. 23, 2025

Related U.S. Application Data
(60) Provisional application No. 63/711,448, filed on Oct. 24, 2024.

(51) Int. Cl. H04L 9/40; H04L 41/16

(52) U.S. Cl. CPC H04L 63/1425; H04L 41/16

(57) ABSTRACT

Systems and methods for detecting malware on routers use transformer-based anomaly detection. System call data and network packet data are collected from a router and transformed into vector embeddings using embedding models such as sys2vec or net2vec. The embeddings are processed by a transformer-based encoder, such as a BERT model, trained with contrastive or contrastive adversarial learning using anchor, positive, and negative samples derived from benign behavior. The resulting model distinguishes anomalous activity, including zero-day and network-intensive malware, from benign behavior with low false positive rates. Detection occurs at the router or hub level, reducing computational overhead on resource-constrained Internet of Things (IoT) devices and enabling real-time protection without reliance on cloud-based solutions. By combining system call and network packet anomaly detection, the disclosed approach provides robust, low-latency, and low-overhead defense against a wide range of malware behaviors in router-managed ecosystems.

### BACKGROUND

1.1 contrastBERT: Behavioral Anomaly Detection for Malware Using Contrastive Learning Background

Behavioral anomaly detection is a rapidly developing and changing domain that lies at the intersection of machine learning and cybersecurity. Although malware detection is an active area of research, much of it relies on classification models, which are less useful in this space due to the many malware variants and obfuscation techniques malicious actors employ. Modern malware can obfuscate its behavior sufficiently to appear different from known malware stored in an anti-virus database. Because of this, a promising way to detect malware in this ever-changing problem space is anomaly detection, where normal behavior can be modeled and no known malware is needed to train a detector. This type of anomaly detection also makes the task for malicious actors more difficult, as they need to understand how each system is designed and how it behaves to make their mimicry malware appear benign.

Just a few years ago, researchers in this space were using simple natural language processing (NLP) techniques for data transformations, such as bag-of-word n-grams and term frequency-inverse document frequency (TF-IDF). Since then, transformer models have revolutionized not only behavioral anomaly detection but also the artificial intelligence community and society. The effects of this phenomenon have been seen in everything from deep-fake videos to AI assistants writing code using tools like Cursor and CoPilot. These recent advances were influenced by a paper entitled “Attention is All You Need” by Vaswani et al., a paper that extended the work of Bahdanau et al., which eliminates the need for recurrent and convolutional models.

The vanilla Bidirectional Encoder Representations from Transformers (BERT) model was published the following year, introducing the concept of training with context from both directions, rather than in a left-to-right fashion as with other models at the time. Although there have been many advances in transformers in the past six years, the BERT models, which are maintained by Hugging Face, remain useful for research in custom model training, with several variations of BERT including ROBERTa, DistilBERT, and ALBERT.

2.1 sysBERT: Improved Behavioral Malware Detection Using BERT Trained on Sys2Vec Embeddings Background

The U.S. government reports that the number of worldwide ransomware attack claims increased by 74% from 2022 to 2023. One recent method for effective malware detection is leveraging large language models (LLMs), which can learn patterns from representative data to classify previously unseen data-a skill especially suited to zero-day attacks. In general, LLMs have become ubiquitous recently, especially since the release of ChatGPT in 2022, which has been used in a variety of fields. L

### 3.1 Foglight: Online Anomaly Detection for Routers Using BERT-Based Contrastive Learning Background

Although there are many studies on behavior-based anomaly detection, there are few that examine online anomaly detection for real-time detection and decision making. Most studies use offline learning, where data are collected and later fed to a model for training and evaluation. Although such approaches are useful for advancing the state of the art and improving metrics such as accuracy, they lack practical applicability in real-world scenarios.

### 4.1 on the Added Benefit of Contrastive Adversarial BERT for Defending Home Routers Against Network-Intensive Malware Background

Behavioral anomaly detection has been increasingly used to combat stealthy, polymorphic, metamorphic, and zero-day malware. This type of detection has been used to protect smartphones, computers, servers, routers, and even unmanned aerial vehicles.

Behavioral anomaly detection originally used relatively simple models for learning device behaviors, such as one-class support vector machines (SVMs), random forests, and others, but these have largely been supplanted by advanced transformer models over the past several years. Advances in natural language processing (NLP) have enabled security practitioners to leverage embedding techniques originally designed for spoken languages to create specialized language embeddings for device communication. These language embeddings can range from static embeddings such as Word2vec, to learnable, dynamic embeddings in models such as BERT.

Home routers serve as an important component in any network, as the network traffic of every device in a home network passes through it. These home networks are often overlooked by security analysts but are of critical importance with the increase in Internet of Things (IoT) usage in the home. Related work shows that the use of a specialized language, called sys2vec, for Linux kernel-level operating system calls can be used for home router protection. However, this disclosure showed that this approach did not work as well for network-intensive malware. For example, advanced persistent threat (APT) malware are difficult to detect using only system calls because while APTs traverse the filesystem of compromised machines, their activity is focused more on exfiltrating data stealthily using the network.

### SUMMARY OF THE EMBODIMENTS

This application describes four related approaches, each of which represents an evolutionary step in the development of behavioral malware detection for routers using large language models (LLMs). For clarity, the technical disclosures are organized into Sections 1, 2, 3, and 4, each corresponding to one stage of this progression, where the first number in each section “1,” “2,” “3,” and “4” describes each relevant background, summary, brief description, and detailed description, with corresponding Figure lead numbers (the figures leading with “5” are tables, and the second number of each corresponds to each section).

In Section 1 (contrastBERT), the inventors describe using contrastive learning for anomaly detection on routers. System calls were modeled as a language (via sys2vec embeddings) and passed into a custom-trained BERT encoder with triplet loss. This approach shows that anomaly detection can outperform traditional classification, providing resilience against polymorphic and zero-day malware and reducing dependence on pre-existing malware signatures.

Building upon this foundation, Section 2 (sysBERT) refined the approach by demonstrating that sys2vec embeddings could be used not only with GRU/Attention models, but also as input to a masked language model (MLM) based on BERT. This architecture provides greater contextual awareness of system behavior, yielding improved detection of stealthy threats such as advanced persistent threats (APTs), while maintaining a low false-positive rate.

The work then advanced in Section 3 (Foglight/calBERT), which addressed the practical deployment challenge by moving from offline experiments to online anomaly detection. Here, the inventors introduced a distributed fog architecture in which routers collect system calls and network packets via eBPF sensors, with inference performed on a nearby hub running calBERT. This design enabled near-real-time detection while preserving router performance, thereby bridging the gap between laboratory accuracy and field applicability.

Finally, Section 4 (net2vec with contrastive adversarial BERT) focused on malware behaviors that are primarily network-intensive and difficult to capture through system calls alone. To address this, the inventors developed a new packet-oriented language, net2vec, in which network traffic metadata is abstracted into vocabulary tokens. These embeddings are used to train a contrastive adversarial BERT model, complementing sys2vec-based system call detection. The results showed that a hybrid system, combining Sections 1-2 system-call anomaly detection with Section 4's network-based detection, is necessary for robust router defense.

Together, Sections 1 through 4 illustrate a coherent research trajectory: from initial exploration of transformer-based anomaly detection, to improved embedding and model design, to real-time edge deployment, and finally to expanded coverage of network-intensive malware. This progression highlights both the novelty and the practical utility of the disclosed embodiments.

In particular, the disclosed approaches achieve at least the following significant technical effects: (i) reducing false positives to levels compatible with real-world deployment, (ii) enabling router-level detection that avoids computational overhead on resource-constrained IoT endpoints, and (iii) providing low-latency protection that improves the security of router-managed ecosystems.

These improvements collectively provide concrete advantages over conventional malware detection techniques, including enhanced resilience to zero-day threats, improved scalability across heterogeneous IoT environments, and reduced reliance on cloud-based detection. The technical effects are achieved by integrating sys2vec and net2vec embeddings with transformer-based encoders trained using contrastive and adversarial methods.

1.2 contrastBERT: Behavioral Anomaly Detection for Malware Using Contrastive Learning Summary

The inventors trained a custom BERT model using contrastive learning. The BERT framework provides the embedding layer and the encoder. The input data to this model are kernel-level operating system calls collected on a Linux router that serves an Internet of Things (IoT) ecosystem. This ecosystem includes multiple devices and communication protocols, making it realistic for evaluation. System calls provide a representation for the activities that happen on a device because every process running on the device uses them to ask the kernel for the resources needed to execute its task. The system calls act as a proxy for system behavior that does not require any modification to the systems themselves, and include familiar tasks such as read, write, and close. The system calls are collected during times of strictly benign behavior, which are used for training the model (and separately for evaluation), as well as periods of malicious behavior, in which the inventors filter the data to collect only system calls run by processes that are started by the malware. This is necessary to ensure that only malicious behavior is recorded in the malicious data. In general, malware exhibits common behaviors that appear in a wide range of malware. In this disclosure, the inventors call these common behaviors malware patterns, which the inventors later define and use. Additionally, the inventors create a stealthy Advanced Persistent Threat (APT) malware for evaluation. These are explained in detail in Section 3.

Each system call is embedded into 64-length vector representations using a custom-trained model the inventors call sys2vec, which is a model trained from scratch using the Word2vec model framework provided by a package called Gensim. This model provides vector embeddings that allow system calls to be semantically grouped by functionality, such as grouping file I/O operations, network socket operations, and more. The sys2vec preprocessing step provides additional context for the model before being passed into the BERT embedding and encoder layers.

The vectors are then separated into anchors, positive examples, and negative examples to be used in a custom triplet loss function based on the cosine similarity metric between vector representations outputted from the BERT encoder. One of the most important aspects of training a contrastive model with triplet loss is the selection of the triplets, which the inventors explain in detail below.

After the contrastBERT model is trained, the pipeline output is evaluated using a simple (single variable) isolation forest available from scikit-learn. The isolation forest is fit on benign data unseen during training, which allows the inventors to determine the generalization of this method more effectively than by splitting one dataset into training and testing sets. After fitting the model with benign data, the inventors predict whether eight different unknown datasets, collected during times of malware execution, are anomalous or not. The results for each of these malware patterns are shown in FIG. 5.1.2.

The experimental results indicate that the model not only distinguishes benign from malicious behavior, but also does so without prior knowledge of any malware flavor, since only benign data are used for training. This result is useful in combating modern malware, such as zero-day attacks, since no prior knowledge is necessary to detect a malware infection with high efficacy.

2.2 sysBERT: Improved Behavioral Malware Detection Using BERT Trained on Sys2Vec Embeddings Summary

LMs are often used for text generation and other language-specific tasks; however, the inventors seek to demonstrate how the power of LLMs can be applied to malware detection using a non-traditional language: sequences of kernel-level system calls.

The data used for malware detection are kernel-level system calls from a Linux router in an IoT Ecosystem, which has different configurations depending on the devices connected and are discussed in detail below. Kernel-level system calls provide a low-level, complete representation of all activity on-device, allowing machine learning models to accurately infer whether unseen behavior is occurring. After collecting data representing the benign behavioral profile of each configuration, the Ecosystem configurations are subjected to infection with a few different malware families, including ransomware and Advanced Persistent Threat (APT), as discussed herein. After the raw system calls are collected, they are passed through a custom-trained Word2vec-like model, called sys2vec. sys2vec provides contextual embeddings for the system calls, similar to how Word2vec provides vector representations for English and other language vocabulary sets.

Using the sys2vec embeddings, the inventors trained a Bidirectional Encoder Representations from Transformers (BERT) masked language model (MLM) to train an encoder for the fine-tuning classifier. The MLM provides more context from both sides of an observed system call, which is invaluable to increasing the performance of the classifier. Instead of using the typical BERT embedding block, the MLM uses sys2vec embeddings as input because the inventors found that this custom architecture yielded better results. As such, the MLM also does not use BertTokenizer, since the system calls have already been transformed to be input to the BERT encoder.

The idea of using sys2vec embeddings as direct input to BERT aligns with a finding from previous work, which showed that sys2vec embeddings were a special ingredient that improved the efficacy of a classifier based on a GRU and an Attention layer. The difference between the work described in this disclosure and previous work is that the inventors demonstrate a custom pre-trained encoder from the BERT MLM to provide greater context, and, thus, greater classification performance than was possible using the previous work's GRU with an Attention layer. These findings are discussed in further detail herein, in which the results of the BERT-based classifier match or outperform the results of the GRU-based classifier in almost all of the cases.

To quantify results realistically, the inventors assess the models' efficacy using the true positive rate (TPR) at an acceptable FPR≤1×10−5. Given the sampling rate of the data, this caps the number of false alarms to tens of false alarms per week. Although this metric yields a lower true positive rate than is normally found in machine learning cybersecurity research, it provides a more accurate representation of how the findings could be used in practice.

Finally, the inventors describe future work and directions given findings and recent model architectures.

### 3.2 Foglight: Online Anomaly Detection for Routers Using BERT-Based Contrastive Learning Summary

The goal of this paper is to show how routers can be protected by building a practical online behavioral malware detection framework that can be deployed using an innovative model trained using contrastive adversarial learning. The inventors show that this framework can detect several types of malware within about 1 second with a low false positive rate of about 0.01.

The inventors call this framework foglight, because it uses the emerging fog architecture common in enterprise systems. The benefit of using a fog framework is that it reduces its reliance on the cloud and associated network latency by performing most of its computation at the edge of the network. foglight has three main components: the Agent, which is responsible for online anomaly detection, the Tower, which manages the Agents and communicates messages from the Agents to the user, and the Application Programming Interface (API), which is the connection point for foglight to plug into existing security solutions. The next few paragraphs focus on the Agent, as this is the machine learning (ML) component and the innovative part of foglight.

The Agent first collects kernel-level system calls and network traffic packets from a Linux router that serves a network ecosystem using a custom Extended Berkeley Packet Filter (eBPF) sensor suite. The network ecosystem includes several devices that use common communication protocols, such as WiFi, Bluetooth low energy (BLE), and Zigbee. The streams of system calls and network traffic data are sent instantaneously from the router to another device on the network called the hub. Data are passed through the calBERT model, residing on the hub, for model inference. The inference results are subsequently sent to a Grafana dashboard residing in the AWS cloud for real-time router health monitoring. Performing model inference on the hub ensures that router performance is not adversely affected by the anomaly detection process.

calBERT is a custom-trained Bidirectional Encoder Representations from Transformers (BERT) model that uses contrastive adversarial learning for training. This type of learning is suitable for anomaly detection because contrastive samples are mined strictly from benign data, yet the model generalizes when it is introduced to malicious behavior during inference. In other words, the model is robust in detecting different flavors of malware without prior exposure to such data, making it ideal for detecting zero-day attacks.

To evaluate the model, the inventors subjected the router to several types of malware behaviors that are commonly found in the wild, such as downloading code from the Internet, compiling such code, and exfiltrating data. The inventors then calculate the average time-to-detection, which measures the time elapsed from the initial execution of malware until its detection on the hub using calBERT. Although there is some variability in these elapsed times due to varying network conditions, TTD is an insightful estimate of how well calBERT is expected to detect malware in the wild.

FIG. 5.3.1 shows the time-to-detection results of various malware patterns and their false-positive rates. Based on these results, calBERT can protect routers by quickly detecting malware that executes on them, without increasing its false-positive rate, using both system call and network traffic data.

### 4.2 on the Added Benefit of Contrastive Adversarial BERT for Defending Home Routers Against Network-Intensive Malware Summary

In this disclosure, the inventors focus on the added benefit of securing home routers by collecting network packets to and from home routers and inferring representative home router behavior. This approach differs from sys2vec's system call-based detection, which captures a comprehensive firehose of kernel-level events performed on behalf of userspace programs. In contrast, the inventors developed a new language called net2vec that focuses specifically on network events enriched with packet metadata, providing semantic context beyond simple event occurrence and enabling more precise detection of network-intensive malware. Network packets were collected from a router in a typical home ecosystem and is traffic originating from or destined to the home router. This includes communication from the router to an AWS-hosted IoT dashboard and to other devices on its network, such as a laptop. It also includes any malicious network activity involving the router, such as downloading code from a website on the Internet, as discussed later.

The data are collected during periods of known benign behavior, which is completely free of malware infection, as well as separately during periods of malware infection. Several types of network-focused malware are used in this disclosure, which are described in detail herein. To isolate malicious behavior, rather than using a mixture of benign and malicious behavior, only packets with process identifiers (PIDs) matching those generated by the malware during execution are considered when evaluating the malware dataset.

The packet data are processed to select a subset of available fields, such as specific IP addresses and port numbers, and then place them into abstract categories, which are then concatenated. The result is that specific data such as port 22 would become a category called SourcePortWellKnown and the concatenation of these categories would represent an abstraction of each packet into a single word. These sequences of words are then fed to the net2vec model, which creates 64-length embedding vectors for each distinct word seen in both the benign and malware data collection. This ensures that there are no gaps in the vocabulary and that the inventors have the most well-formed packet combinations in the vocabulary as possible. These embeddings are then used to train a contrastive adversarial BERT model using a large dataset of benign home router behaviors.

The data are split into 50-word sentences, which were chosen through experimentation with the data, and anchor samples, positive samples, and negative samples are created from these sentences. The mining of these samples is crucial for the triplet loss to perform well and for the model to converge during training. In this disclosure, the anchor sample is each sentence in the benign behavior data; the positive sample is the next sequential sentence; and the negative sample is a randomly chosen sentence at an index greater than the positive sample. This triplet selection scheme is shown in detail in FIG. 4.4. The negative sample is then mutated prior to being passed into the model by selecting different categories for the data, bucketed by randomly choosing one of several logical choices. The mutation strategy is shown in more detail in FIG. 4.5. the inventors also tried to train the model using only a random negative sample without mutation, but the model was unable to learn effectively using this configuration.

The BERT model learns how to distinguish the data by trying to bring the positive sample closer while simultaneously pushing the negative sample further away from the anchor during the learning process. It was found that a higher mutation rate performed better than a lower mutation rate in this disclosure.

The disclosure shows that while the network-based model is effective at detecting malware behavior involving networking tasks, it is ineffective for tasks that do not involve network activity. This led the inventors to explore combining behavioral anomaly detectors for operating system and network activities.

The network testbed in this research is a fully functioning, realistic ecosystem consisting of several devices communicating via various protocols. This testbed enables model training on authentic network traffic from a typical home network and does not rely on carefully curated datasets from common malware repositories. While this type of data collection may limit direct comparisons with other behavioral anomaly detection research, the research contribution is enhanced by providing security practitioners with a set of tools and techniques that can be applied to any real-world home network. The only requirement is a modern Linux kernel for data collection, a common standard in today's computing community, making this research highly applicable for real-world deployment.

### Practical Advantages

The disclosed systems and methods provide significant technical improvements over conventional malware detection approaches. By modeling router behavior at the system call and network packet levels and applying transformer-based anomaly detection, the invention achieves high detection rates for previously unseen malware, including zero-day attacks, while maintaining an exceptionally low false-positive rate. This reduction in false positives ensures that the malware detector remains practically useful.

Furthermore, the system executes anomaly detection at the router level, rather than requiring each Internet of Things (IoT) endpoint device to run separate security software. This reduces computational overhead on resource-constrained IoT devices and preserves their performance for intended tasks. By leveraging a fog architecture with hub-level inference, the invention enables near-real-time detection while avoiding the latency and network congestion associated with cloud-only detection solutions. These improvements collectively provide a concrete technical effect: robust, low-latency, and low-overhead malware detection that improves the security of router-managed ecosystems.

### BRIEF DESCRIPTION OF THE DRAWINGS

1.3 contrastBERT: Behavioral Anomaly Detection for Malware Using Contrastive Learning Brief Description

FIG. 1.1 shows example IoTOwl server readings from the AWS server, including from the air quality sensor, the Zigbee light bulb, and the pulse oximeter.

FIG. 1.2. is a chart showing how sys2vec is able to capture context between semantically-related system calls; The dimensionality has been reduced from 64 to 2 using PCA.

FIG. 1.3 is a chart showing sys2vec embeddings reduced from 64 dimensions to 2 using PCA. This shows how sys2vec is capable of clustering system calls semantically by showing examples of common system calls like read, write, open, and close.

FIG. 1.4 shows triplet selection comprises an anchor, a positive, and a negative sentence, where the negative sentence is randomly selected from unseen vectors. In this example, sentences between Sk-1 and Sn are choices to select from randomly.

FIG. 1.5 shows contrastBERT architecture-the lifecycle of a system call from individual system call, like open, to passing it through the custom triplet loss function.

FIG. 1.6 shows cosine similarities or the lateral malware pattern. The FIG. shows how the lateral cosine similarities are mostly separable from the benign datasets.

FIG. 1.7 shows cosine similarities for the APT malware. The FIG. shows how the APT is very close to the benign datasets, and there is some benign extending to the left side of the graph.

FIG. 1.8 shows contamination sweep for lateral malware. Note that the x-axis scale is only from 0.00 to 0.05 to provide a zoomed-in view. The figure shows the isolation forest efficacy at several contamination rates. Using a contamination rate of 0.025 results in 100% detection and minimizes the false positives as much as possible while maintaining that detection rate, while using a lower contamination rate, such as 0.005, results in a better false positive rate but only about 33% true positive rate.

FIG. 1.9 shows a contamination sweep for APT malware. Note again that the x-axis scale is only from 0.00 to 0.05 to provide a zoomed-in view. For this malware, the true positive rate stays much closer to 0 until a 0.022 contamination rate is used. This means that there is much less of a tradeoff here, because without that high of a false positive rate, the detector is unusable.

FIG. 1.10 shows an ablation study evaluating the impact of type of embedding (sys2vec vs. fixed random) and isolation forest input (mean of pairwise cosine similarities vs. raw BERT embeddings) on the average of malware detection across malware patterns as a function of the contamination rate. For FPR≤2, sys2vec using cosine similarities generally performs best and is thus the method examined in detail in FIG. 5.1.2. For higher false positive rates, there is less dependence on using sys2vec and cosine similarities.

2.3 sysBERT: Improved Behavioral Malware Detection Using BERT Trained on Sys2Vec Embeddings Brief Description

FIG. 2.1 shows an example IoT Ecosystem configuration: a Pulse Oximeter bluetooth device connected to the user-facing server via a router.

FIG. 2.2 shows an example 2D PCA projection of sys2vec vectors.

FIG. 2.3 shows classifier architecture: from raw system call, through sys2vec, through a custom-trained BERT encoder, to a benign/malware prediction.

FIG. 2.4 shows an example of how classifier losses and alpha values look when α=1.0.

FIG. 2.5. shows an example of how classifier losses and alpha values look when 0.5≤α≤1.0.

3.3 Foglight: Online Anomaly Detection for Routers using BERT-based Contrastive Learning Brief Description

FIG. 3.1 shows the Foglight Platform Architecture. The three main components are the Agent, Tower, and API.

FIG. 3.2 shows the calBERT architecture: From raw system call or network traffic packet, through sys2vec/net2vec (denoted*2vec), through a custom-trained BERT encoder, to the custom triplet loss function.

FIG. 3.3 shows alpha value change for system calls during training.

FIG. 3.4 shows an example Grafana dashboard capturing the health of a monitored edge device.

### 4.3 On the Added Benefit of Contrastive Adversarial BERT for Defending Home Routers Against Network-Intensive Malware Brief Description

FIG. 4.1 shows the network ecosystem showing many of the devices used in this disclosure. The goal was to create a realistic ecosystem comprised of popular and emerging protocols as well as smart devices you might find in a home today.

FIG. 4.2 shows an IoTOwl dashboard residing on AWS. This displays current sensor readings from the air quality sensor, the pulse oximeter, and the Hue light bulb.

FIG. 4.3 shows the linux kernel eBPF attachment points for network observability, the inventors intercept data at the Socket layer to associate network traffic with individual processes in userspace.

FIG. 4.4 shows an example of how the random negative sentence could be chosen from forward-looking sentences unseen in previous anchor and positive selections. The randomly chosen negative is then mutated as shown in FIG. 4.5.

FIG. 4.5 shows an example mutation of a word, with mutated fields shown in red. The brackets are for illustration purposes only and not a part of the words. The mutation rate is set to 50%.

FIG. 4.6 shows contrastive adversarial BERT model architecture. This shows the transformation of a raw packet through its generalization, embedding vectorization, and pass through BERT into the custom contrastive loss function.

FIG. 4.7 shows cosine Similarities for the download malware. The spread between the benign distributions and the malware distribution is quite large due to the malware's singular task of downloading code from git, which yields fairly uniform cosine similarities.

FIG. 4.8 shows visualization of how the KDE interacts with the cosine similarities, where the values are normalized. This example shows the diversity of cosine similarities in the benign datasets while being confined to the area close to 1, whereas there is a lack of diversity in the malware vocabulary. Additionally, it shows how far the download cosine similarities are able to be spread from the malware distribution.

FIG. 5.1.1 shows a table showing number of observations for each dataset. Note that the number of observations for the benign system calls are truncated to 1M observations, while the non-benign dataset totals are shown after PID-filtering, meaning the total system calls observed correspond directly to malware execution.

FIG. 5.1.2 shows a table showing detection rates of malware samples at varying contamination levels, defined as the percentage of samples flagged as anomalies. The inventors show both sys2vec input vectors as well as fixed random input vectors to compare the relative effectiveness of both using the contrastBERT model. These results all use cosine similarity in the evaluation.

FIG. 5.2.1 shows a table showing the main results averaged over twenty separate runs. The TPR and FPR are shown assuming only approximately tens of false alarms per week are acceptable. This translates to FPR≤10-5 based on the sampling rate. Highlighted portions in yellow represent best TPR given FPR for given malware. Highlighted portions in green represent best AUC for given malware.

FIG. 5.3.1 shows a table showing time-to-detection (TTD) results for each malware type using syscall and network packet data over ten separate runs. TTD measures how quickly an agent could respond to an ongoing infection. All times are in seconds. For comparison, the false positive rate for syscalls was 12/1017=0.01; for network packets, 6/500=.

FIG. 5.4.1 is an example JSON record of a network event. This event in particular is a query from the listener on the router to the air quality sensor to get updated sensor readings, which are then sent to the IoTOwl server on AWS.

FIG. 5.4.2 is further development showing the IP addresses are bucketed into the following groupings, which defaults to “Public” if no matches are found.

FIG. 5.4.3 shows the other fields retained from the packets are bucketed into the following groups.

FIG. 5.4.4 is a table showing a comparison of detection rates, measured as the percentage of malware falling within confidence intervals, between the optimal system call training configuration (adversarial/non-adversarial) and the network packet-based configuration. improvements from using network packets shown in bold.

### DETAILED DESCRIPTION OF THE EMBODIMENTS

The inventors propose systems and methods that apply machine learning (ML) and large language models (LLMs) to secure routers in a variety of environments, including residential and enterprise networks. Representative behavioral data are collected from routers in the form of kernel-level system calls and network packet metadata, which together provide a robust basis for distinguishing normal operation from anomalous or malicious behavior. Unlike traditional endpoint security software, the disclosed approach performs detection at the router level, thereby reducing computational overhead on resource-constrained IoT devices. In exemplary embodiments, a Linux router equipped with WiFi, Bluetooth, and Zigbee-connected IoT devices is instrumented with an efficient logging framework to capture behavioral data. These data are transformed into vector embeddings and processed by transformer-based encoders trained using contrastive or adversarial learning to produce accurate benign or malware predictions with low false-positive rates.

1.4 contrastBERT: Behavioral Anomaly Detection for Malware Using Contrastive Learning Description

### 1.4.1 Related

### 1.4.1.1 Behavioral Malware Detection

Traditionally, malware detection was conducted by signature matching, which compared suspicious binaries to known malware binaries stored in anti-virus company databases. This method has fallen out of favor as the primary detection method because malware has evolved to become more stealthy. Two types of malware have led the way: metamorphic malware, which changes its code on each replication, and polymorphic malware, which encrypts its executable files. These two types of malware make systems vulnerable to zero-day attacks, as it is no longer possible to scan their binary files and compare them with known malware binaries.

As this has become the case, behavioral malware detection has become an increasingly preferred approach. Behavioral malware focuses on creating a behavioral profile of a system in a benign state to compare against potentially infected states, rather than relying on code analysis. This method is more robust to unknown threats, which makes it more effective against malware that is previously unseen or malware that has obfuscated its binary code or its behavior.

### 1.4.1.2 Contrastive Learning

The contrastive learning technique used to train the BERT model was first introduced using triplets of data in the training process. The triplets included two similar samples, called an anchor and a positive example, and a dissimilar example, called a negative example. The goal of the training process is to separate each pair of positive examples from negative examples using a distance margin.

This algorithm was originally developed to help with facial recognition software developed by Google, but has since been used for other applications. These include object tracking, as well as several types of anomaly detection, including detecting video anomalies and driving anomalies using a conditional generative adversarial network.

There are many ways of setting up the loss function using triplet loss, a few of which are implemented for use in PyTorch, such as TripletMarginLoss and TripletMarginWithDistanceLoss. In this disclosure, the inventors chose to train using a custom loss function based on the cosine similarities between the anchor and the positive example, and between the anchor and the negative example, because they found that using cosine similarity for loss calculation between examples yielded superior results. The custom loss function is defined in Section 1.4.3.

### 1.4.1.3 Large Language Models for Anomaly Detection

Anomaly detection problems can be characterized as “finding a needle in a haystack,” and because of this, the introduction of the Attention mechanism and the resulting transformer models have largely left traditional ML models behind, thanks to their capacity for large amounts of context, which improves performance.

The most visible LLMs today are generative pre-trained transformers (GPT), like OpenAI's ChatGPT and Google's Gemini. Some work has been done on the use of GPTs for anomaly detection, such as the work by Ali et al., which used GPTs to help create HuntGPT, an intrusion detection dashboard built on a random forest (RF) model. In this example, the GPT model is used to create a conversational agent to convey any detected threats in an easily digestible format.

A different study addressed the use of an LLM to detect semantic anomalies, which the authors described as system-level failures in semantic reasoning within autonomous systems, such as the autopilot features of a Tesla. Their proposal to counter these semantic reasoning failures was to insert an LLM to act as a monitor within the autonomous system to identify any anomalies it encounters.

There are also works related to malware classification using LLMs, which focus on detecting Android malware using an OpenAI model. This differs significantly from this disclosure, which focuses more on anomaly detection rather than classification, which is more useful for zero-day attacks, and the inventors used a custom-trained model that is built specifically for the system call language.

### 1.4.2 Technical Approach

### 1.4.2.1 Data Collection

The data used in this disclosure includes kernel-level system call data from a Linux router connected to multiple IoT devices residing in an ecosystem, which the inventors call IoTOwl. An observability platform the inventors created, called SkyShark, is used to collect the system calls. SkyShark uses the Linux subsystem eBPF for the efficient logging of all system calls that occur on the device.

eBPF allows user programs to run safely in the kernel. These programs can register interest in targeted kernel services, such as system calls that enter or exit the kernel, and stream real-time data with high performance and granularity. SkyShark provides several customization parameters for the type of data to collect, in addition to the raw system call numbers, such as timestamps and filtering by a subset of process IDs (PIDs). In this case, the inventors chose to log all system calls along with the calling process IDs for all processes running on the device, since they did not know ahead of time which processes might be infected by malware.

The devices connected to the ecosystem use three types of common IoT communication protocols and include the following:
PurpleAir PA-II Air Quality Sensor (WiFi)
BerryMed Pulse Oximeter (BLE)
Google Home (WiFi)
Philips Hue Light Bulb (Zigbee)
A phone and laptop (WiFi)

Each IoT device, including the air quality sensor, pulse oximeter, and light bulb, sends its sensor data to the Linux router, which acts as a gateway to a server running on an Amazon Web Services (AWS) EC2 instance using Prometheus and Grafana. The malware execution and system call collection happen on the router, while the AWS server simply displays dashboards and visualizes the sensor readings from the IoT devices. This includes current temperature and humidity readings, blood oxygen and pulse readings, and current brightness, hue, and saturation of the Philips bulb. Sending the current sensor readings to the AWS server allows for a more realistic environment in which to collect the system call data.

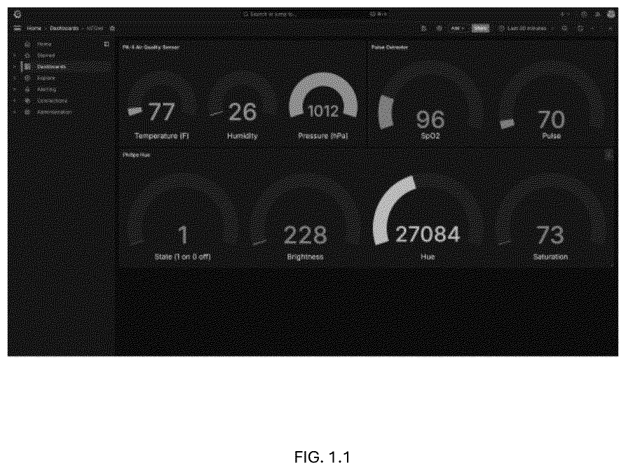

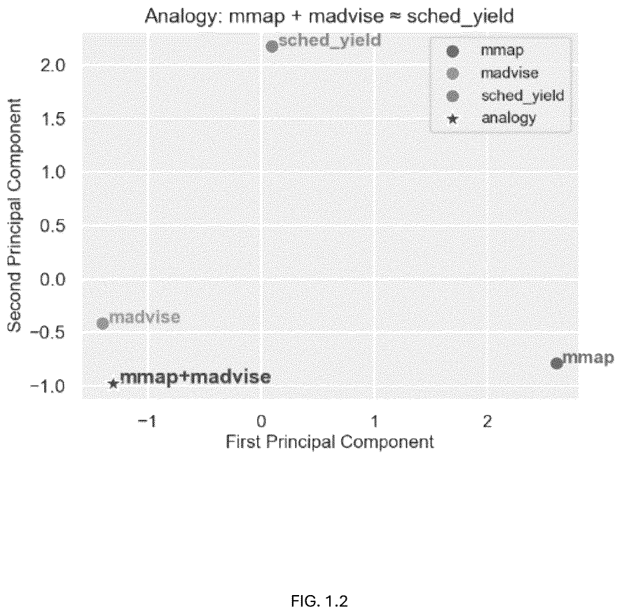

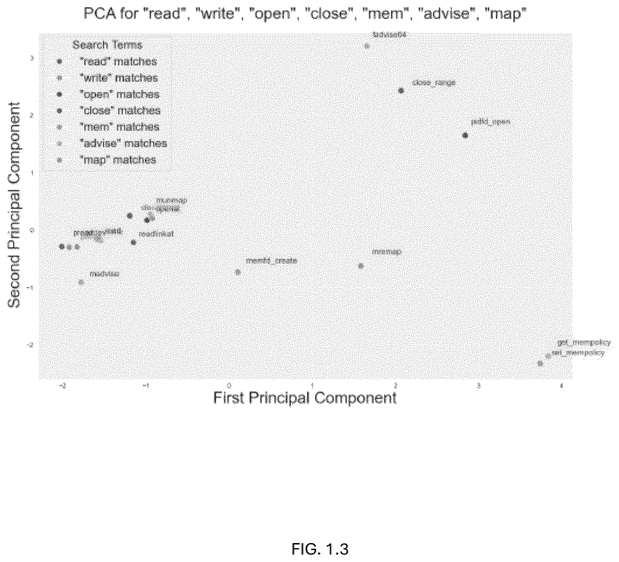

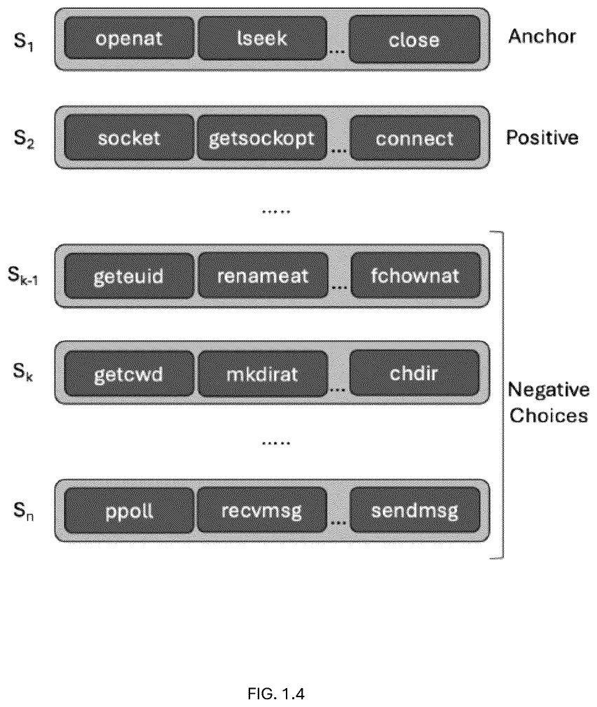

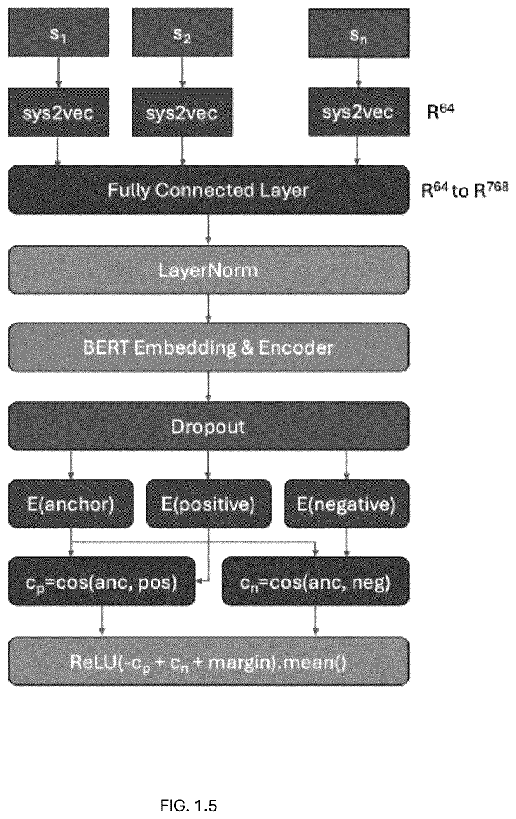

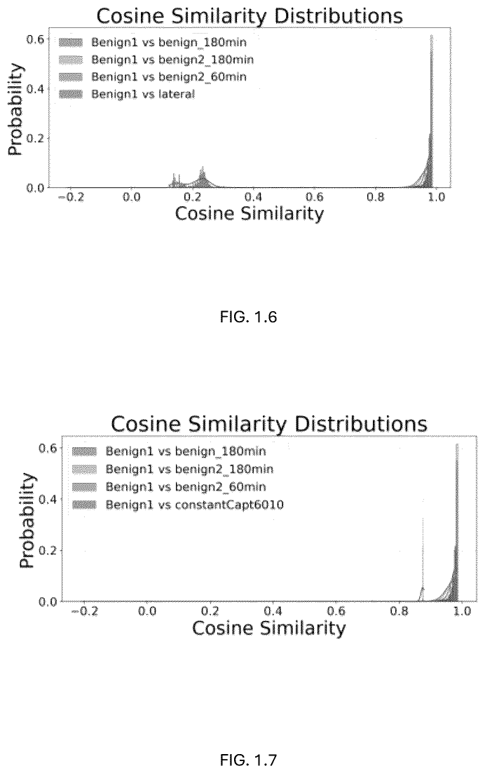

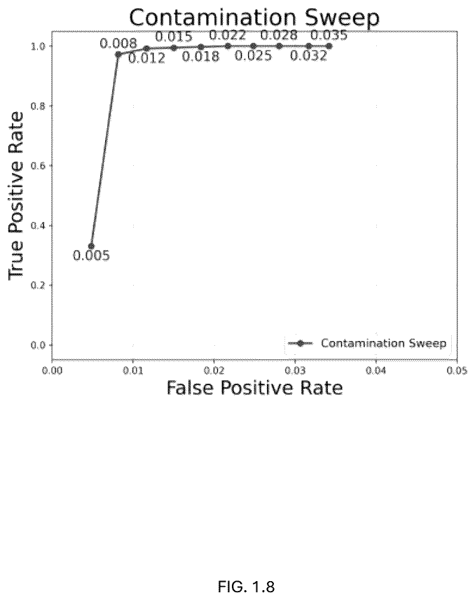

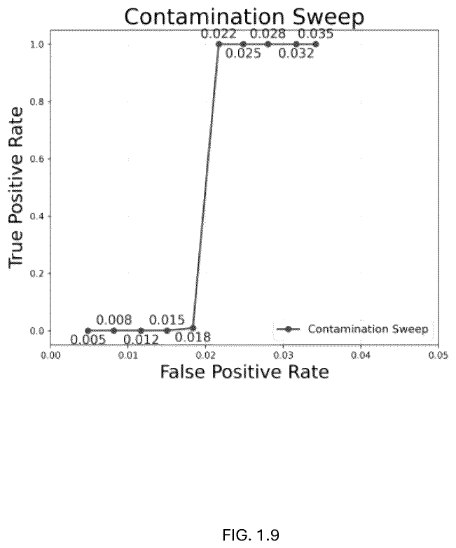

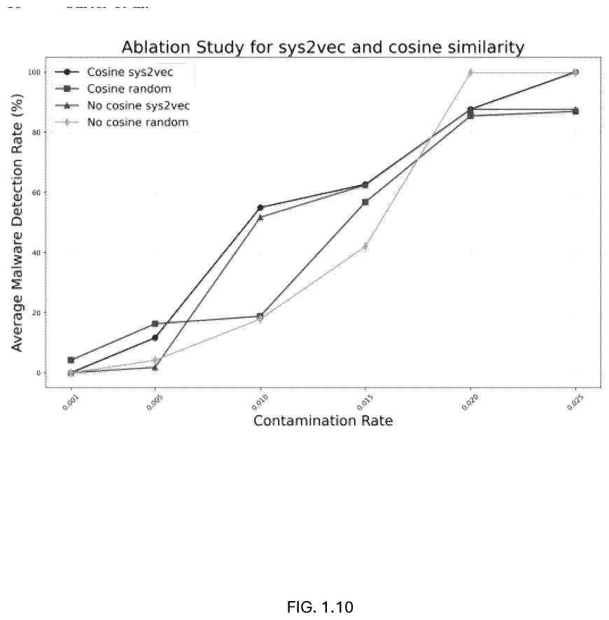

An example of how the server might look in operation is shown in FIG. 1.1, which is a screenshot of the server residing in AWS. The screenshot shows a real-time data display from the PA-II air quality sensor, the Philips Hue bulb, and the pulse oximeter sensor, showing things like temperature, humidity, pressure, etc.

### 1.4.2.2 Malware

Malware Patterns. Several types of malware may be used to evaluate this disclosure, including a collection of malware behaviors that the inventors denote as malware patterns. These patterns are designed to emulate the behavior of malware from the moment it lands on a device until it executes. For this disclosure, the inventors identified the following malware patterns. Each of these is implemented to be simple and lightweight, both for simplicity purposes and for generalizability.

The first behavior is download, which downloads code from a git repository and removes it. This emulates malware behavior after the malware lands on the device and attempts to connect to a server to download its malicious code.

The next behavior is traverse, which navigates the file system and runs a stat on each file it encounters. This emulates a surveilling malware that is looking for sensitive files that contain passwords, financial data, and other types of private data to exploit.

Another behavior is encrypt, which traverses the file system and encrypts each file using the gpg command. This malware emulates many types of malware that look at files and then encrypt them to make them unusable to the file owner, most notably in ransomware, which has been an increasingly expensive problem over the last decade.

Next is the rename behavior, which traverses the file system, renames each file, and then restores the original name. Though this seems to be a trivial malware behavior, it emulates how a malware might find a file, and then rename it to put it in another location to hide it from its owner.

Another behavior is compile, which compiles C code into executable files and subsequently removes them. This emulates many types of malicious code that need to be compiled to run, as running C code is much more lightweight than running code of an interpreted language, like Python, and thus makes it less noticeable.

The combo malware seeks to combine several of the most common patterns into a comprehensive malware type by first downloading code from the Internet, compiling it, and then traversing the file tree, encrypting/decrypting each file it encounters.

The last core malware behavior the inventors explored is lateral, which attempts to access sensitive password files, such as/etc/shadow, and then uses ping to identify active IP addresses on the subnet. Subsequently, it tries to SSH into each of them to perform a lateral movement on the network.

Advanced Persistent Threat. In addition to these general behaviors, the inventors created an Advanced Persistent Threat (APT), which is designed to be a stealthy malware that slowly exfiltrates data without being detected. As noted above, it is written in C to be more lightweight and less detectable. It is implemented using the standard client-server architecture, in which a server waits for a client to connect, and as soon as the client connects, it starts sending files for exfiltration.

The APT provides a bandwidth-limited parameter that allows the user to exfiltrate data very slowly, making detection more difficult. A bandwidth limit of 100 kilobytes per second was chosen to strike a balance between the amount of exfiltrated data that is useful and the need for stealth. It also provides sleep time and run time parameters that allow users to specify how long the APT should run and how long it should be dormant between exfiltration times.

### 1.4.2.3 Data Preprocessing Using Sys2Vec

Before passing the system call data into the model for training, it is first passed through a custom trained Word2vec model, called sys2vec. Although the BERT model used during training has its own embedding layer, passing the sys2vec vectors to the model at the start provides it with even more context, thereby improving results. The sys2vec model was trained for 100 epochs and used a sentence length of 500 contiguous system calls, which was found to be optimal for computing efficiency and contextual sufficiency. The data used for training sys2vec comprise several datasets that contain only benign data from the device. 486,345 sentences were used for training, and the embedding length of each vector is 64. The final vocabulary size is 164, since the inventors only observed 164 system calls during the extensive benign data collection processes.

The sys2vec model can learn the relationships between system calls. The first provides a classic analogy to depict how normal algebraic expressions can be performed on the vector representations of words. In this case, a pertinent example is King-Man+Woman=Queen, while in the current case using system calls, a pertinent example is mmap+madvise≈sched_yield. This example is reasonable since, after mapping memory, processes might call madvise using the MADV_DONTNEED option, which can cause the OS kernel to yield control to another scheduled process waiting for service. FIG. 1.2 depicts the example using PCA dimensionality reduction, where sched_yield is the closest vector in the vocabulary to the mmap+madvise expression.

FIG. 1.3 provides an example of sys2vec embeddings for a variety of related and unrelated system calls. This figure depicts the strengths and weaknesses of sys2vec's ability to cluster functionally similar system calls, such as write and writev, as well as semantically close system calls like openat, read, write, and close. As shown in the figure, the model performs well in grouping many of them, such as the read and write-related system calls, but does not do as well with madvise and fadvise64, for example.

### 1.4.2.4 Triplet Selection

The inventors swept over a range of parameters to select the best type of triplet data to train the model, as the quality of the triplet data can make all the difference when training a contrastive learning model.

After selecting the anchor, which is each sentence in the data, and the positive example, which the inventors chose to be the next sequential sentence in the data, the negative sample was constructed using a random sample that has not yet been seen as the inventors loop through the data. In other words, the random negative sample is a sentence between the current positive sample and the total number of sentence vectors. For example, if the anchor is S0, the positive example is S1, and the negative sample is chosen from sentences in the range S2 to Sn. FIG. 1.4 shows this triplet relationship in more detail.

### 1.4.2.5 Triplet Loss

The loss function of the model is designed to separate positive and negative examples and is defined as follows, where cos (a, b) denotes the cosine similarity between two vectors:

L=E[max(0,−cos(a,p)+cos(a,n)+margin)] EQ 1.1

During the experimentation process, the inventors also tried using the PyTorch function TripletMarginLoss using Euclidean distance as the distance metric between the anchor, positive, and negative examples. This provided useful results, but the inventors found that the use of cosine similarity between vectors generated superior results. The triplet loss formula, and the steps leading to it, are shown in FIG. 1.5.

1.4.2.6 contrastBERT Training

The architecture of contrastBERT is shown in FIG. 1.5, which describes the life cycle of a single system call observed through the custom loss function.

The first layer (S1 . . . Sn) shows an observed system call, which is subsequently passed through the sys2vec layer, where it is transformed into a 64-length vector. This static embedding provides an initial context for the BERT model during the training process. As part of an ablation study, the inventors also trained a separate BERT model using random 64-length embeddings to show the relative difference in performance with and without using sys2vec. The inventors normalized the random vectors to reduce the influence of the magnitude of the vectors, though the inventors did try non-normalized random vectors for completeness and found it yielded worse results overall. The random vectors are fixed for all of the data used in this disclosure. Next, the data are passed through a fully connected layer to expand their dimensionality from 64 to BERT's standard dimensionality of 768. The data are then passed through a LayerNorm layer, before being passed to the BERT Embeddings( ) layer and the BERT Encoder. The BERT Embeddings( ) layer provides additional dynamic embedding context that builds on what is provided by the sys2vec embeddings.

Once the data are passed through the encoder and a Dropout layer, the data are pooled using mean pooling, and then the anchor, positive, and negative example sentences are all normalized. The cosine similarity is then taken between the anchor and the positive example and between the anchor and the negative example. These two cosine similarities form the basis of the custom loss function, which aims to pull the positive example closer to the anchor while pushing the negative example away.

1.4.2.7 contrastBERT Evaluation

For evaluation, the inventors test using three separate benign datasets in addition to the malware dataset being evaluated to assess the generalizability between similar, yet distinct, benign datasets. Although the ecosystem configurations are identical for each of the benign data collections, there can sometimes be noise in the data, for example, from kernel activity or Domain Name System (DNS) updates.

Using several benign datasets during evaluation ensures that the model is not learning a single dataset but rather a more general benign behavioral profile. In total, four datasets are used in the evaluation of each malware pattern: one benign, denoted benign1, a second, separate benign, denoted benign2, a third, separate benign, denoted benign3 and an unknown dataset, denoted unknown. The number of observations for these datasets, as well as for each of the malware datasets, is shown in the table shown in FIG. 5.1.1.

Similar to the model training phase, the inventors compare the usefulness of the sys2vec embeddings as part of the ablation study during the evaluation phase and pass the raw system call datasets through both the sys2vec model to generate the 64-length embeddings as well as using the fixed normalized random embeddings as input to contrastBERT. Both types of embeddings are then passed separately through the contrastBERT model to obtain the 768-length embedding vector from the BERT encoder.

Pairwise cosine similarities are taken for benign1 and itself, benign1 and benign2, benign1 and benign3, and benign1 versus unknown. After computing pairwise cosine similarities, the inventors take the mean of each dataset's pairwise cosine similarities. Examples of the resulting mean of pairwise cosine similarities are depicted in FIGS. 1.6 and 1.7. FIG. 1.6 for the lateral malware shows cosine similarities that are very separable from benign, while FIG. 1.7 for the APT malware shows cosine similarities that are less separable from the three benign similarities. The mean of each of the pairwise cosine similarities between the three benign datasets is used to fit an isolation forest. The inventors also tried using the embeddings themselves to fit the isolation forest directly as part of the ablation study, but this generally yielded slightly worse results. FIG. 1.10 shows the average malware detection at several isolation forest contamination with and without cosine similarities as well as using sys2vec embeddings versus fixed random embeddings.

The isolation forest is an off-the-shelf model from scikit-learn, which uses all default parameters except for the contamination rate, which is the expected ratio of anomalies in the training dataset. The inventors swept over a number of rates to find the optimal parameter for the problem space, as depicted in FIGS. 1.8 and 1.9. These figures show the tradeoff between detection rate and false positive rate for the lateral and APT malware. In the next section, the inventors explore three contamination rates in detail, which bring into focus the tradeoff between detection and false positives.

### 1.4.3 Experimental Results

The table shown in FIG. 5.1.2 shows the results for all types of malware from the isolation forest using both sys2vec and fixed random embeddings and three contamination rates:
0.005, 0.015, and 0.025. These contamination rates were chosen to illustrate the tradeoff between detection rate and false positive rate referred to in FIGS. 1.6 and 1.9.

Overall, the results show that using a contamination rate of 0.025 results in high detection efficacy of 100% across all malware patterns using sys2vec embeddings and almost 100% for random embeddings, but with it an average false positive rate across the benign datasets of 2.5%. Similarly, using a 0.015 contamination rate yields usable detection for five of the eight malware patterns, with a lower 1.50% false-positive rate using sys2vec embeddings, and for four malware patterns using fixed-random embeddings. This contamination rate might be preferred for a use case in which a low false-positive rate is more important than the best possible detection. Lastly, the 0.005 contamination rate yields essentially unusable results for all malware patterns examined, save perhaps for the traverse malware pattern using fixed random embeddings.

As shown in the table in FIG. 5.1.2, the false positive rate can be lowered for some malware patterns using a lower contamination rate, such as in FIG. 1.8, but the detection rate falls accordingly. However, for some malware, such as the APT shown in FIG. 1.9, a higher contamination rate is necessary for detection.

### 1.4.4 Conclusion

In this disclosure, the inventors collected system call data from a Linux router serving a real IoT ecosystem, which was then passed through an ML pipeline consisting of the custom sys2vec embedding model and a custom-trained anomaly detection model the inventors call contrastBERT. The anomaly detection model is trained using contrastive learning, which uses triplets of data composed of an anchor, a positive example, and a negative example. For each sentence in the training data, the first sentence is the anchor, the second is the positive example, designed to be most similar to the anchor, and the third is the negative example, which is selected randomly from the unseen sentences at the time of processing each anchor.

After training contrastBERT, the inventors passed new testing data through sys2vec and contrastBERT and used the resulting embeddings to compute pairwise cosine similarities between each of the four evaluation datasets and benign1, and took the mean of the pairwise cosine similarities. These similarities were used to fit an isolation forest using varying contamination rates to illustrate the tradeoff between detection rate and false positive rate. These values are shown in the table in FIG. 5.1.2.

The inventors also conducted an ablation study to determine how useful the sys2vec embeddings were to the overall pipeline by training a separate contrastBERT model on fixed random vectors in place of the sys2vec vectors and using the same vectors for evaluation of the model. FIG. 1.10 illustrates the general performance tradeoff between the two and the table in FIG. 5.1.2 provides more detail for each type of malware. Generally, it was found that the sys2vec embedding pipeline slightly outperformed the fixed random embedding pipeline.

The sys2vec and contrastBERT pipeline detected malware perfectly at a 0.025 contamination rate, though this came with a false-positive rate of about 2.5%, which may be high for some problem domains. Because of this, the inventors also tried using a 0.015 contamination rate. This yields excellent results for about half of the malware patterns examined and a lower false-positive rate of about 1.5%. A more false-positive-conscious problem domain may prefer this contamination rate, since it still yields usable results for many malware patterns. Lastly, the inventors found that a 0.005 contamination rate with a 0.5% false positive rate yielded nearly unusable results for most malware.

The contribution of this research work is a highly effective ML pipeline that uses sys2vec and contrastBERT to detect a variety of common patterns of malware behavior running on a router in a realistic IoT ecosystem. The inventors custom-designed the sys2vec embedding framework as well as the contrastBERT model using contrastive learning specifically to be used in a system call language space. The use of anomaly detection for malware detection rather than classification provides a more robust solution since no prior malware knowledge is needed to train contrastBERT, making it especially suitable for zero-day malware.

2.4 sysBERT: Improved Behavioral Malware Detection Using BERT Trained on Sys2Vec Embeddings Description

### 2.4.1 Related

### 2.4.1.2 Behavioral Malware Detection

Traditional malware detection used static signature analysis, which meant matching potential malware binaries against known malware binaries stored in an anti-virus database. Although those approaches work and are still used today, malware has evolved to use obfuscation techniques such as packing and encryption, which have made signature matching less useful in practice. Some examples of these advanced malware include polymorphic and metamorphic malware. As a result, malware detection has increasingly moved towards behavioral malware detection as the solution. Behavioral malware detection seeks to understand and model malware behavior rather than compare its bit patterns with known malware in a database, making it more useful for unknown malware and zero-day attacks. In other words, instead of needing to have previously seen that malware to compare it to known malware, behavioral malware detectors can detect that the device is behaving out of the ordinary and needs attention by observing runtime system data.

### 2.4.1.3 Word2vec

Word2vec was a tremendous leap forward in Natural Language Processing (NLP) because of its innovation in modeling word similarities. It proposed two novel architectures to create vector representations of words, and has been used extensively in the NLP field since its introduction in 2013. Although Word2vec has inspired work on modeling word vectors in hundreds of languages, to the inventors' knowledge, its application to system calls is much more limited.

One example of using a Word2vec model for representing system calls focused on intrusion detection and used only an LSTM for evaluation, which the inventors found to produce suboptimal results for the stealthier malware included in this disclosure. Another example used unsupervised learning by extracting system calls from binaries and then applying Word2vec to create contextual embeddings for each system call, which were then fed into a couple of ML models. The best performing model used XGBoost and had a log-loss score of 0.12. This disclosure used a Cuckoo sandbox environment (though the disclosure is not limited to this) to collect Win32 API system call functions, which differ significantly from the problem space, which runs in a real environment on a Linux router.

### 2.4.1.4 BERT

Bidirectional Encoder Representations from Transformers (BERT) was introduced in 2018 as a transformative new language model that conditions on context from both the left and the right Since then, BERT has been used extensively in NLP, and there has been recent research into using it for malware detection.

One example uses BERT as a form of feature engineering on opcode sequences. The resulting embeddings are then fed to a range of machine learning classifiers, such as a kNN (82% accuracy), random forests (RF) (95% accuracy), support vector machines (SVM) (94% accuracy), and convolutional neural networks (CNN) (94% accuracy). Another example uses BERT to create word embeddings from opcodes of malware samples and compares the results with Word2vec embeddings, using classifiers such as SVM and RF. The random forest model provided the best accuracy using either Word2vec or BERT, achieving accuracies of 89.6% and 91.81%, respectively.

Although these studies provide useful information to build on, they differ significantly from what was done here and discussed in this section. One difference is that their studies use opcodes from malware samples, while this disclosure uses raw Linux system call sequences captured in a real environment. Another difference is that while other studies have compared results between using a Word2vec-like model and a BERT model, to the inventors' knowledge, there has not been work that uses Word2vec-like system call embeddings as input to a BERT model.

### 2.4.2 Data Collection Requirement

### 2.4.2.1 Raw System Call Sequences

The data used in this disclosure are raw system call sequences observed and recorded on a Linux router residing in an IoT Ecosystem. This Ecosystem includes IoT sensors, such as an air quality sensor, a cloud server where the sensor data can be seen by a user, and a router that connects them. The system calls are collected using a custom tool called jtrace, which acts as a wrapper for the Linux ftrace function by listening to its output pipe and logging the system calls to a file. ftrace is a widely-used tool that can perform a variety of kernel tasks, such as function tracing and calculation of function duration. The logged system calls include a timestamp, a process ID (PID), and a function name. The system calls are collected during 30-minute periods of benign behavior and of known malware infection (which also includes benign behavior).

### 2.4.2.2 IoT Ecosystem

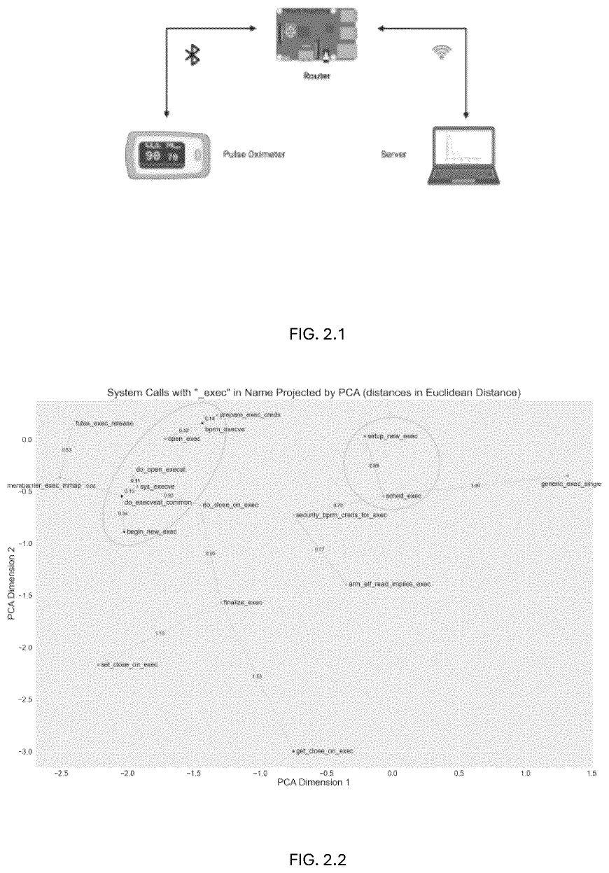

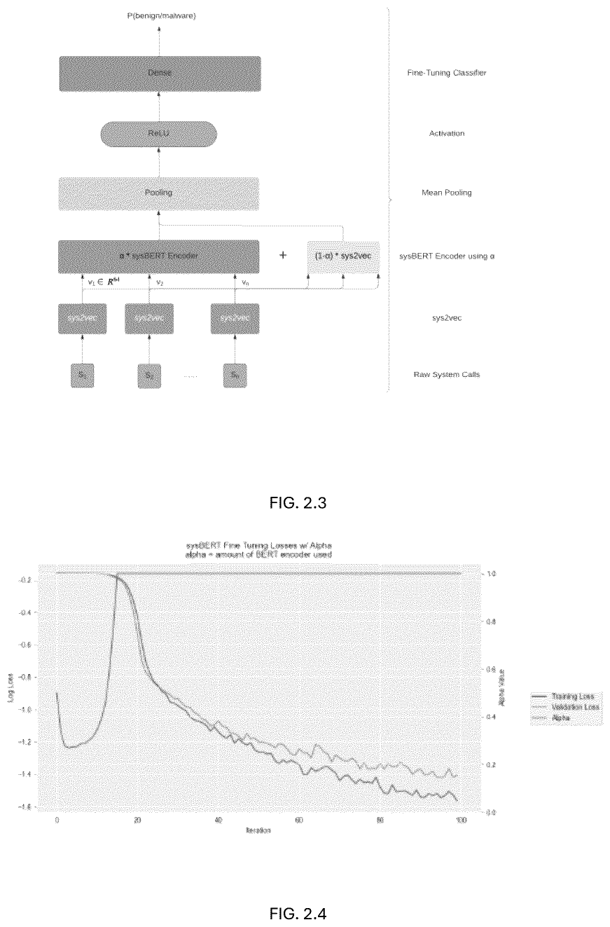

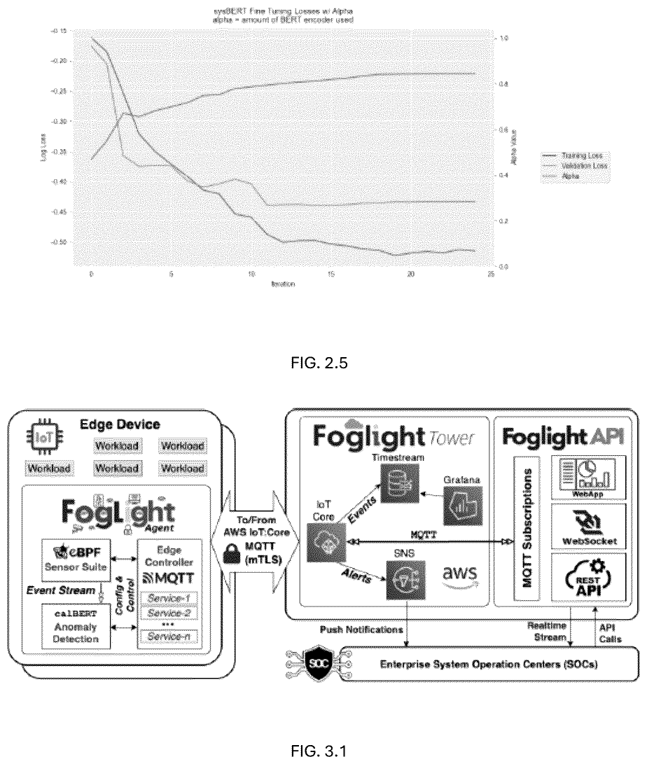

As mentioned, the IoT Ecosystem in general includes three main components, depicted in FIG. 2.1. The first is the IoT device, which in the configurations act as sensors to send data to the server via bluetooth low-energy (BLE) or WiFi. Three types of sensors are used in this disclosure:
Texas Instruments SensorTag: a BLE device that has a range of sensors, such as a thermometer and light sensor, and reports them to the server
PA-II Air Quality Sensor: a WiFi device that reports on the air quality at regular intervals
BerryMed Pulse Oximeter: a BLE device that reads a user's pulse and blood oxygen level and reports them to the server

All three of these devices were used in various configurations, which are listed in the table shown in FIG. 5.2.1.

The second part of the Ecosystem is the router, which communicates with the devices via either BLE or WiFi and then communicates with the server via the Internet. The malware and the system call logger both reside on the router. Lastly, the server is an application that resides in the cloud and displays the sensor readings from the IoT devices to users.

### 2.4.2.3 Malware

Several types of malware are introduced to the IoT environment in this disclosure. The first is the Advanced Persistent Threat (APT) malware, which is stealthy malware that tries to exfiltrate data from an infected host to a remote host slowly to evade detection, the inventors use two types of APT malware: the first the inventors call constantapt, which exfiltrates data at regular intervals. In other words, the amount of data exfiltrated and the amount of time it is exfiltrated are the same between runs. The second flavor of APT in this disclosure, the inventors call randomapt, is functionally similar to constantapt but randomizes both the time to exfiltrate and the time to sleep between exfiltrations. Both of these malware walk the file tree of the host they reside in and slowly exfiltrate the data they see. This type of stealthy malware is the hardest to detect.

The second family of malware is netwox, which is meant to emulate a noisy malware landing on-device. This includes the netwox-install malware, which simply means that the network utility netwox is repeatedly downloaded and installed and then purged from the host. This behavior is meant to be similar to a malicious package landing and installing. The second flavor of this malware is random-netwox, which includes the install/purge behavior mentioned above, as well as running a TCP Reset Attack using the netwox tool for a random duration.

Finally, the inventors include a ransomware example for more malware breadth. The ransomware traverses the infected device's directory tree, exfiltrates each file to a remote host, and then encrypts it before moving to the next file.

### 2.4.3 Data Processing Using Sys2Vec

One of the most important factors in any machine learning model is the quality of the input data. Similar to modeling words in the English language, system calls can be treated as a language, though the vocabulary is much smaller. System calls are often executed in a specific ordering given the inventors' task, which means their sequential information can be used to provide contextual embeddings.

To this end, before the data are fed to the MLM or the classifier, they are first transformed using sys2vec. sys2vec is a Word2vec-like model designed to extract meaningful embedding representations of raw system calls. It is built using the open-source Gensim Word2vec framework, which provides methods for training a custom model.

In FIG. 2.2, the inventors show an example Principal Component Analysis (PCA) 2D projection of system calls relating to the exec function call. As shown, sys2vec groups many of them quite well, including those shown in the red, such as setup new exec and sched exec, as well as sys execve, do execveat common, open exec, and begin new exec. However, other seemingly related calls are somewhat further apart, such as set close on exec, get close on exec, and do close on exec, although these are still grouped in the same general area.

Through experimentation, the inventors found that a vector length of 64 per system call embedding optimizes the trade-off between sufficient context and excessive noise. Similarly, the inventors experimented with the sentence length as well, as the classifiers learned better with a longer sentence length, providing more context, while the MLM learned better with a shorter sequence. After much experimentation, the sentence length used for both of the classifiers was 185 system calls, while the sentence length for the MLM was 32 system calls.

### 2.4.4 Machine Learning Models

### 2.4.4.1 BERT Masked Language Model

BERT is a language model developed by Google that conditions on context from both the left and the right BERT is used in a two-step process: pre-training and fine-tuning which the inventors use in this disclosure as well. The pre-training step involves training a masked language model, in which certain random tokens, in this case system calls, are replaced with a mask token. The model then predicts the masked token and refines its predictions using a loss function during the learning process to correctly predict the original token. The fine-tuning step involves using the encoder portion of the MLM in a classifier.

Although it is relatively easy to start using BertForMaskedLM from Hugging Face, these off-the-shelf models often expect the inputs to be English text, which would first be passed through a BertTokenizer before being fed to the MLM. The inventors initially tried using the names of the system calls as input to the tokenizer (after being put into sequences of a fixed sentence length). It was thought that the names of system calls could be similar to English words, and that sequences of system calls could be similar to English sentences. Although this was possible, the results were not good.

Following this, the inventors tried bypassing the BertTokenizer by providing the system call integer representations as input directly to BERT. Similarly, this disclosure was also made, but again yielded results not sufficient for a useful classifier. Lastly, the inventors created a custom class based on BertForMaskedLM that allowed them to feed custom sys2vec embeddings to the encoder without using the tokenizer or the built-in embedding block provided by BertForMaskedLM.

The final MLM used different dimensions than the default values that BERT from Hugging Face uses. A 64-dimensional hidden size was used instead of 768, and a 256 intermediate size instead of 3072. Since the language of system calls is much simpler than a normal spoken language, the inventors were able to reduce the size of the BERT parameter space, which not only made training more efficient, but also improved the results.

Between the sys2vec embeddings and the encoder, the inventors created position embeddings and passed the sum of the sys2vec embeddings and the position embeddings through the built-in LayerNorm and Dropout layers before passing them into the encoder. The encoder outputs are passed through the built-in CLS block before being passed through the Cross-Entropy loss function. After the training process, the MLM was able to predict 94% of the tokens correctly, meaning it understood the context between the system calls well.

### 2.4.4.2 BERT-Based Classifier

Similar to the MLM, the architecture of the classifier is the result of much exploration, since the problem space is significantly different from the problems for which BERT was designed and is frequently used. Initially, the inventors adopted the strategy of employing an unmodified, commercially available product.

BertForSequenceClassification model, which is available from Hugging Face. Although this model produced results, these results were not good enough to improve on the state-of-the-art in malware detection. Most likely the BertForSequenceClassification model was too complex for the problem domain.

From there, the inventors built their own classifier using the encoder from the MLM as the base and added linear and activation layers. The final architecture was obtained from iterative reduction and simplification of the model until it reached its current state, as shown in FIG. 1.3. In the model, the raw system calls are first passed through the sys2vec model, which converts them into sys2vec embeddings.

After this, an α parameter is defined to optimize the trade-off between using the sysBERT encoder and completely bypassing it. The α parameter is initially set to 0.5, so that the model can easily learn if BERT is more or less useful. The formula the inventors followed for this trade-off is α×sysBERT (sys2vec)+(1−α)×sys2vec. In FIG. 2.4, the inventors show how a quickly goes to 1.0 for some malware configurations, while in others, as shown in FIG. 2.5, a stays below 1.0, though 0.5≤α≤1.0 by the end of training. The output of this mixture is pooled using mean pooling. After that, a ReLU activation function is applied, and the output is passed through a dense fine-tuning layer for prediction as either benign or malware. The data was split using 2/3 for training and 1/3 for testing. From the training set, 2/3 was used for training and 1/3 for validation.

### 2.4.4.3 GRU-Based Classifier

For comparison with the BERT-based classifier, the inventors trained a GRU-based classifier that uses Attention, which was previously found to be the state-of-the-art model for classifying stealthy malware such as an APT. This classifier is relatively simple and includes a GRU layer of size 32, an Attention layer, Dropout (p=0.2), and a final dense layer for classification. The data was split using 2/3 for training and 1/3 for testing. From the training set, 80% was used for training and 20% for validation.

### 2.4.5 Experimental Results

### 2.4.5.1 Evaluation Metrics

The results are evaluated using two main metrics: Area Under the Receiver Operating Characteristic Curve (AUC) and the True Positive Rate given an acceptable False Positive Rate. The true positive rate and false positive rate are defined below:

$$TPR = TP / ( TP + FN ) \qquad EQ . 2.1$$

$$FPR = FP / ( FP + TN ) \qquad EQ . 2.2$$

In general, the AUC provides a useful general metric for efficacy of a machine learning model when the false positive rate is a concern. It has also been recommended as a better alternative to accuracy as a “single number” evaluation metric for ML models.

Although the AUC is useful for overall evaluation, the TPR given an acceptable FPR metric is arguably the best measure for how well the model is doing in this domain, because having a low false positive rate is imperative in malware detection. If there are false alarms being thrown at the user regularly, it is likely that the user will grow tired of being bothered unnecessarily and will simply turn off the malware detector. Because of this, the inventors limit the FPR to tens of false alarms per week, which, given the sampling rate of the data, translates to

FPR≤10-5, as shown in the table in FIG. 5.2.1. Rather than simply presenting the accuracy of the model given the optimal threshold, the inventors think this metric presents a more useful metric for how this malware detection could work in real-world environments.

### 2.4.5.2 Results

Using the table in FIG. 5.2.1, the inventors compare using the current state-of-the-art GRU-based model to classify stealthy APT malware to using the BERT encoder-based classifier using the two metrics mentioned previously. Overall, the results show that in all but one case, the classifier using the BERT-based classifier provides the same, or better results, than the GRU-based classifier.

A large increase in performance is shown in line 1 of the table, where the SensorTag IoT device is connected to the router and the randomapt malware is infecting the router. There are 521,139 benign system calls observed and 517,828 malware system calls observed in this dataset. In this case, the TPR using the BERT-based classifier is 0.27 higher than the GRU-based classifier. This translates to a 40% improvement using the BERT-based classifier over using the GRU-based classifier.

In line 2, the air quality sensor is connected to the router and again the randomapt malware is infecting the router. There are 674,034 benign system calls observed and 548,473 malware system calls observed in this dataset. This the only case in which the TPR decreases using the BERT-based classifier relative to using the GRU-based classifier, albeit a slight decrease of 0.03. In this example, both of the TPRs are very high and still useful for effective detection with a low FPR.

In line 3, the SensorTag IoT device is connected to the router and the constantapt malware is infecting the router. There are 521,139 benign system calls observed and 516,343 malware system calls observed in this dataset. In this example, the BERT-based classifier improves the TPR by 0.16 over the GRU-based classifier, for a 145% improvement. Similarly, the AUC is improved by 3%.

In line 4, the SensorTag and pulse oximeter IoT devices are connected concurrently to the router and the constantapt malware is infecting the router. There are 503,657 benign system calls observed and 501,261 malware system calls observed in this dataset. For this example, the BERT-based classifier improves the TPR by 0.21 for a 150% improvement, and the AUC is improved by 3%. These past two findings show that even though the TPR is still relatively low, using the BERT encoder as the core part of the classifier performs much better than using the GRU.

In line 5, the SensorTag and pulse oximeter IoT devices are again connected concurrently to the router and the netwox-install malware is infecting the router. There are 503,657 benign system calls observed and 488,064 malware system calls observed in this dataset. The BERT-based classifier shows a slight TPR increase of 0.05, or 5%, which is reasonable because it is a noisy malware and easily detected, even by simpler ML models.

In line 6 1, the SensorTag IoT device is connected to the router and the constantapt and netwox-install malware are both infecting the router concurrently. There are 521,139 benign system calls observed and 457,060 malware system calls observed in this dataset. This example shows that both perform equally well with a TPR of 1.00, which again is reasonable because of the noisiness of the netwox-related malware.

In line 7, the air quality sensor is connected to the router and the random-netwox malware is infecting the router. There are 674,034 benign system calls observed and 466,837 malware system calls observed in this dataset. The BERT-based classifier shows a slight increase in TPR of 0.01, as again the netwox-related malware is noisy and easily detected in most cases.

Finally, in line 8, the pulse oximeter is connected to the router and the ransomware malware is infecting the router. There are 566,038 benign system calls observed and 522,910 malware system calls observed in this dataset. In this case, the BERT-based classifier shows a TPR increase of 0.08, or 9%.

Overall, the AUC achieved by the BERT-based classifier always matches or exceeds the AUC achieved by the GRU-based classifier. Likewise, in all but one instance, the BERT-based classifier matches or exceeds the TPR performance of the GRU-based classifier, in some cases by increasing the TPR by over 100%. the inventors believe these findings to be reasonable, as the BERT model is able to provide significantly more context between the system calls than the GRU model can. The BERT model was also able to achieve this using a much more simplified model architecture than the BertForSequenceClassification model available off-the-shelf from Hugging Face.

### 3.4 Foglight: Online Anomaly Detection for Routers Using BERT-Based Contrastive Learning Description

### 3.4.1 Related Work

Although there has been work in the area of online anomaly detection, the area has been much less explored than traditional offline anomaly detection using static datasets. One online anomaly detection study looks at the effectiveness of a framework for testing the quality of data streamed in a large telecommunication framework. This is relevant to this disclosure in terms of the use of steams of data but differs in its immediate application. Another study examines online anomaly detection for sensor systems and highlights their requirements such as accuracy, robustness, resource efficiency, and performance.

### 3.4.2 IoTOwl Ecosystem

The Linux router used in this disclosure section serves a local network including several Internet of Things (IoT) devices and a consumer laptop.

The connected IoT devices include the following:
PurpleAir PA-II air quality sensor (WiFi)
BerryMed pulse oximeter (BLE)
Google Home (WiFi)
Philips Hue light bulb (Zigbee)

These devices use a variety of communication protocols that are common or emerging in IoT ecosystems, such as WiFi, BLE and Zigbee. Each of these devices is connected to the router via its respective protocol, where a listener program for each device gathers the latest sensor readings and sends them to a separate server on AWS used only for IoT sensor readings. the inventors collectively call the IoT device listener programs and the server displaying their readings the IoTOwl ecosystem. The ecosystem provides a useful testbed for data collection, as this setup is common among home routers that serve both traditional connected devices and emerging smart home technology.

### 3.4.3 Malware Patterns

These patterns were discussed above in Section 1.4.2.2.

### 3.4.4 Foglight Architecture

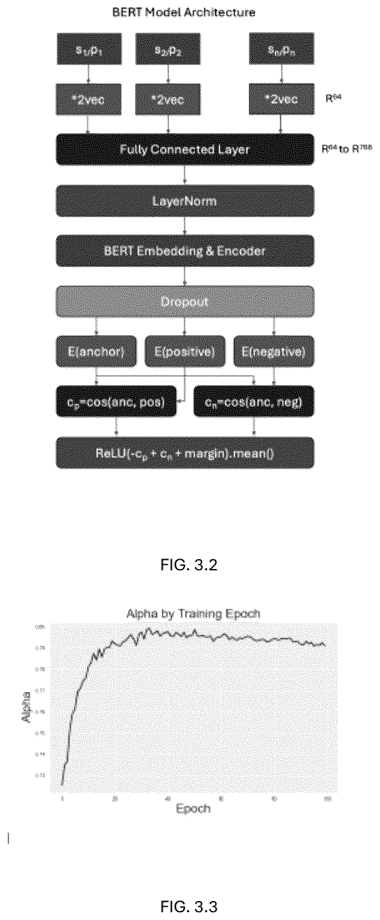

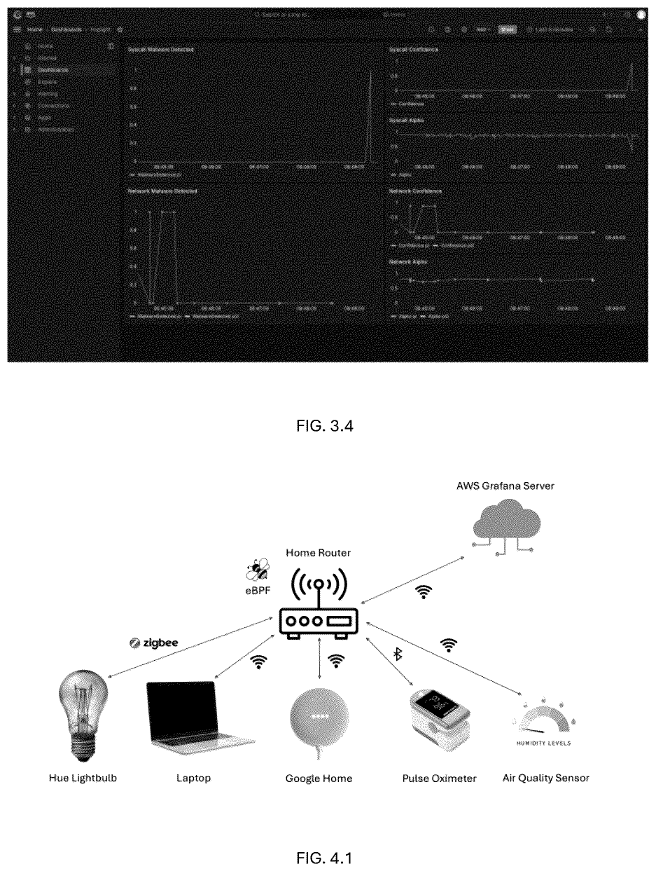

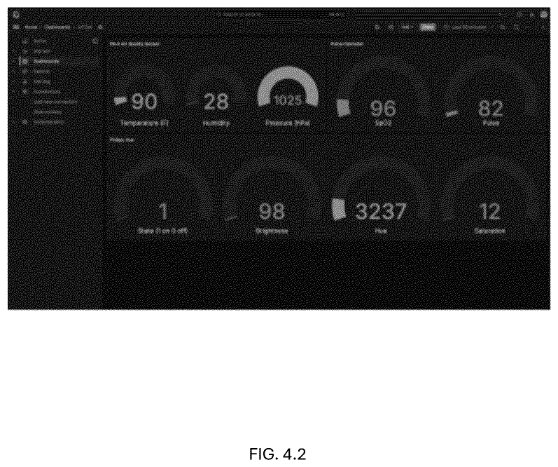

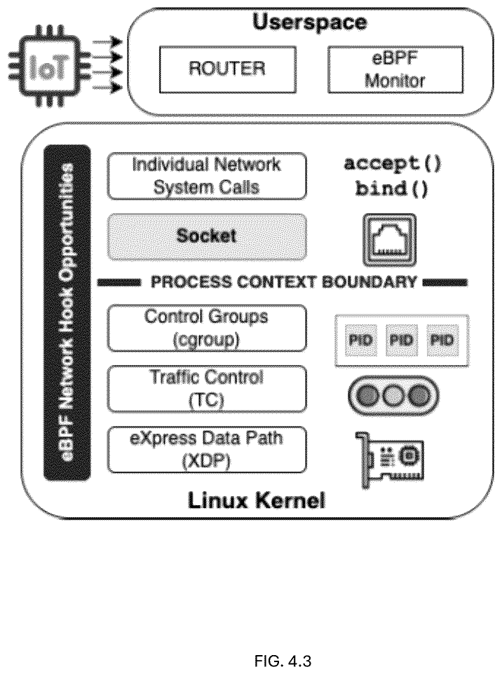

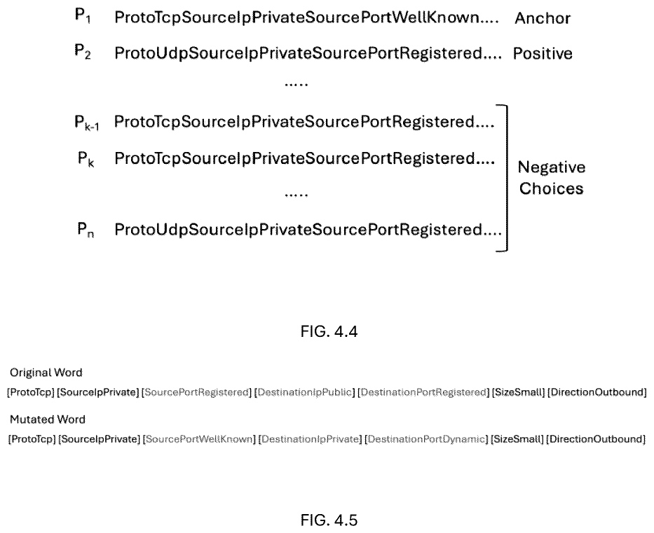

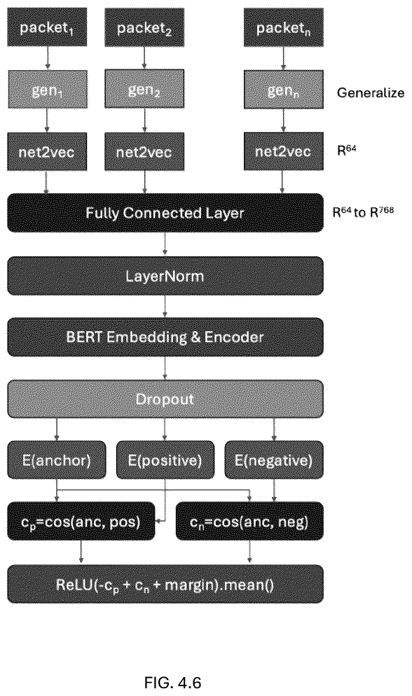

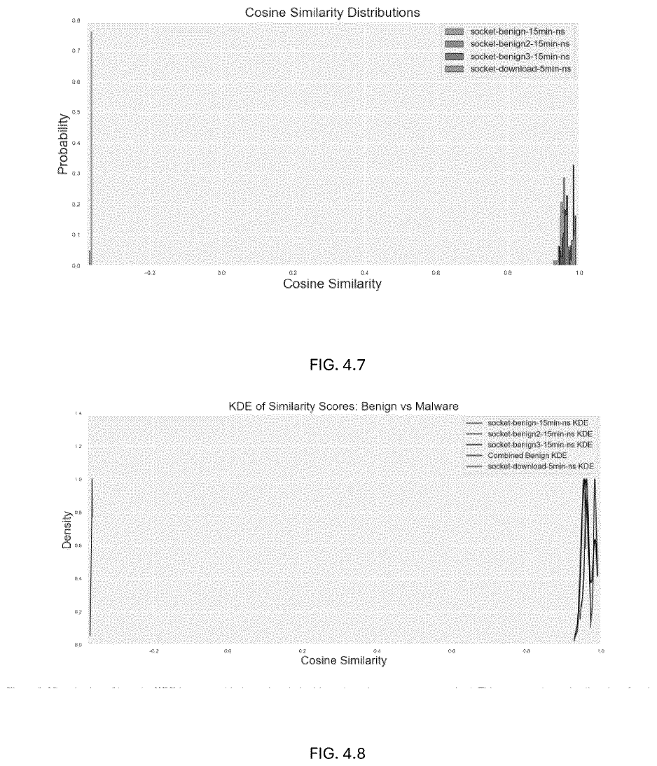

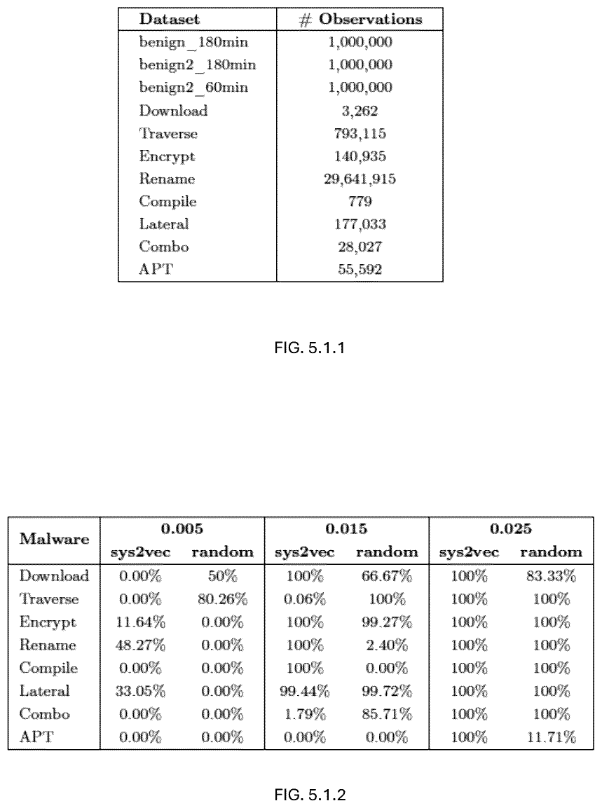

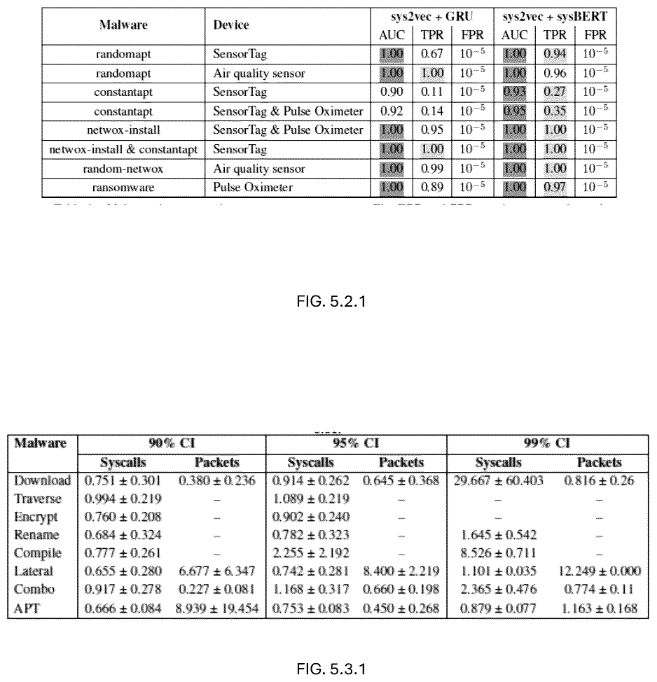

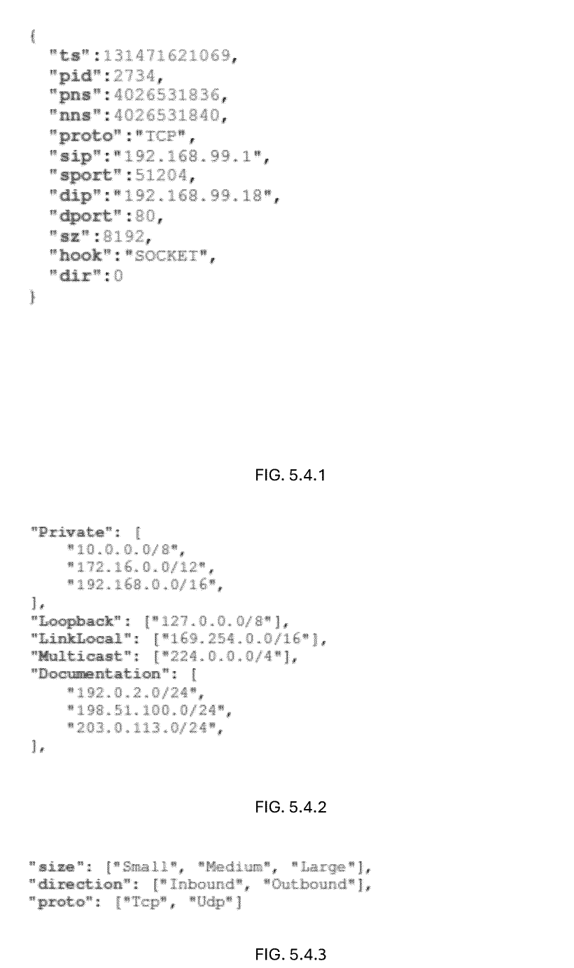

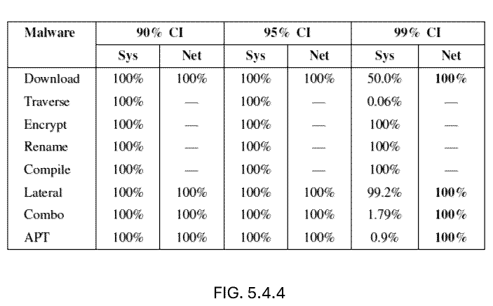

The architecture of foglight is shown in FIG. 3.1. This distributed system uses fog computing principles to perform the heavy computation close to the network edge. By collecting system call and network packet data locally and performing router anomaly detection on the hub, the system eliminates round-trip delays inherent in traditional cloud-centric security solutions.

foglight includes three components that are described in the following subsections. The first component is the Agent that runs on devices such as home routers, performing local anomaly detection. The next several sections describe this component in detail. The second component, the Tower, is a suite of managed cloud services (IoT Core, Timestream, Simple Notification Service, and managed Grafana) that uses cloud infrastructure to manage the fleet of deployed agents. The final component is the Application Programming Interface (API) that enables third-party companies, such as Internet Service Providers (ISPs), to monitor device fleet (router) health, manage anomaly detection configurations at the edge, and coordinate mitigation responses when suspicious behavior is detected. Each of these components communicates with each other using MQTT messaging.

### 3.4.4.1 Foglight Agent

The foglight Agent shown on the left side of FIG. 3.1 implements a layered edge security architecture and has three key components: kernel-space data collection for system calls and network packets, calBERT anomaly detection inference on the hub, and cloud integration that enables the agent to participate as a managed endpoint within a fleet of monitored devices. Multiple eBPF sensor suites execute in the Linux kernel space to monitor system call traces and network packets with a small overhead. This instrumentation detects suspicious malware behaviors through system call and network packet data without requiring application changes, providing direct access to low-level system operations that serve as a realistic proxy for userspace application behavior. The event streams collected from the eBPF sensors are fed directly into calBERT for real-time anomaly detection.

The Edge Controller serves as the central coordination point for the agent architecture and manages all communication with cloud services, handles the configuration of eBPF sensors and calBERT, and executes mitigation actions when threats are detected locally. The controller uses secure MQTT messaging for bidirectional cloud communication. This publish-subscribe architecture ensures reliable delivery of malware detection alerts to cloud services and mitigation directives that are sent from external management systems via the foglight API.

The architecture facilitates the distribution of computational load by performing inference operations on the network edge while centralizing policy management and fleet orchestration in the cloud tier. This design enables rapid malware detection by processing events locally rather than transmitting large volumes of event data to cloud services, while maintaining centralized visibility through ongoing health telemetry reporting.

Event stream communication between the eBPF sensor suite and the calBERT anomaly detection component is implemented using a messaging framework called Cloud Native Computing Foundation (CNCF) NATS. This design enables flexible deployment configurations in which the calBERT component can execute either co-located on the agent device or distributed across separate network nodes.
3.4.4.1.1 Data Preprocessing After system calls and network packet traffic are collected using the custom eBPF sensor suite, the inventors need to preprocess the network traffic data. The raw structure of these data is different since system calls are a single string and packets contain more metadata. For this reason, each network packet is preprocessed to convert the metadata into a single string. The end result is that the complete set of system calls and the preprocessed network packets each serve as a fixed vocabulary for system call and network packet events, respectively. The packet data contains metadata for IP addresses, ports, and packet size. This preprocessing of network packets is essential because the use of specific IP addresses, ports, and packet sizes is a value that would fail to generalize during model training.

To mitigate this, the inventors developed a bucketing process in which specific fields, such as IP addresses, are grouped into categories like “Public” and “Private”. Similarly, ports are characterized as “WellKnown”, “Registered”, or “Dynamic”, in keeping with the Unix vernacular. The bucketing step helps the model generalize across diverse datasets while still preserving useful aspects of each data point, such as whether the packet is inbound or outbound. An example of a preprocessed (bucketed) packet is:
ProtoTcp
SourceIpPrivateSourcePortWellKnown
DestinationIpPrivate
DestinationPortDynamic
SizeSmallDirectionOutbound.

This is an example of a small, outbound TCP packet from a private IP address, using a well-known port, to a private destination IP address using a dynamic port.

The system call and bucketed network packet data are used to train Word2vec-like models, which the inventors call sys2vec and net2vec, respectively. Both models provide semantic embeddings for each system call observed in the data and each packet abstraction, respectively. The system calls and bucketed packets are transformed into a 64-dimensional vector for each observation. The embeddings provide valuable context between the observations in their respective datasets and have been found to be more explanatory input to BERT than using the typical tokenization process found in natural language large language model (LLM) pipelines.
3.4.4.1.2 calBERT Model The calBERT model uses the BertModel class from the transformers library available in PyTorch. Wrapped around the core BERT model is a fully connected layer to transform the 64-length vectors from the sys2vec and net2vec models to BERT's native 768-length dimension, as well as a LayerNorm, a dropout layer after the BERT model, and mean pooling of the final vectors. The data are then normalized and passed through the custom cosine similarity-based loss function designed for triplet loss. The complete training architecture is shown in FIG. 3.2. The custom triplet loss function shown in Equation 1.
3.4.4.1.3 Triplet Loss. The triplet loss used to train calBERT is similar to other triplet loss calculations, but it uses cosine similarity to compare anchor, positive, and negative samples, the inventors also tried using Euclidean distance with the built-in PyTorch method TripletWithMarginLoss, but it yielded worse results than the cosine similarity with the loss function of Equation 3.1:

$$L = E [ max ( 0 , - cos ( a , p ) + cos ( a , n ) + margin ) ] \qquad EQ . 3.1$$

Using this loss function requires careful selection of triplets, often involving hard negative mining. The simplest option was first explored; triplets of anchor, positive, and negative in sequential order. Next, the inventors tried simply selecting a negative sentence at random. This attempt yielded suboptimal results, and thus required adversarial learning to create diverse negative samples for model training. During the negative selection process for adversarial learning, a random negative sentence is selected to have its content mutated. Note that a set of 500 consecutive system calls constitutes a system call sentence, while a set of 50 consecutive preprocessed network packets constitutes a network packet sentence. For system call sentences, a subset of the words in each sentence is chosen at random and replaced by another subset (of equal cardinality) of plausible system calls. Similarly, for network packets, a subset of the metadata buckets is replaced by another subset of plausible network buckets.
3.4.4.1.4 Anomaly Detection using Cosine Similarities and KDE Next, we created a representative distribution of benign data so that the inventors can determine if subsequent data are part of the benign distribution or not. First, several benign system call and network datasets were collected offline and sent through the preprocessing steps and the calBERT model described above. The inventors then calculated the pairwise cosine similarities between the benign datasets to create a cosine similarity distribution. the inventors then fit a Kernel Density Estimation (KDE) using the benign similarity distribution and the Silverman method. This distribution allows the inventors to evaluate whether subsequent data collected during real-time anomaly detection at 90%, 95% and 99% confidence intervals are, or are not, part of the benign distribution.

Once a KDE is fit on the benign data, a similar process is used for each system call or network packet sentence that is streamed through the detector. Again, the new sentence is passed through preprocessing and calBERT, and then pairwise cosine similarities are computed between the resulting embeddings and the benign sentences mentioned above. the inventors then use the KDE to integrate from −∞ to the mean of pairwise cosine similarities using the built-in function integrate box 1d. The integral provides the p-value for each sentence. The p-value is then passed through the exponential moving average formula, described in detail below, and a detection decision is made.
3.4.4.1.5 Exponential Moving Average An exponential moving average (EMA) is used to assign a proportional weight to both the current sentence under observation and all of the previous observed sentences. The EMA smooths the p-values described above by looking at the general trend of p-values instead of looking at the p-value of the current sentence exclusively. The EMA also uses bias correction to provide more accurate initial p-value trends. This results in a reduction of false positive rates below the expected 10% for the 90% confidence interval to about 1% for system call and network packet sentences. The original EMA formula used is shown in Equation 3.2, while the bias correction formula is shown in Equation 3.3. For both equations, ct refers to the p-value for the current sentence, while vt-1 refers to the smoothed p-value representing the previous sentences up to time t-1.

$$vt = α \cdot ct + ( 1 - α ) \cdot {v}_{t - 1} \qquad EQ . 3.2$$

$$vt = [ α \cdot ct + ( 1 - α ) \cdot vt - 1 ] / [ 1 - {( 1 - α )}^{t} \qquad EQ . 3.3$$

To find an optimal parameter a, the inventors trained a shallow neural network using a small sample of benign and malicious data using Equation 2. The resulting model weights are used by the online detector, which passes the current and previous p-values through the α model for each sentence. Separate models were trained for system call and network packet data. An example loss trace graph from training the α parameter for the system call model is shown in FIG. 3.3.

The research contribution of the foglight Agent is an innovative BERT model called calBERT, which is trained using contrastive adversarial learning with only benign data. Anomaly detection uses pairwise cosine similarities and the KDE, which is a less obvious but effective way to create a distribution of benign data from which to detect whether an incoming sentence is benign or not. This LLM pipeline is applicable to additional malware and other types of input data, such as BLE data, making it a robust solution.

### 3.4.4.2 Foglight Tower

The foglight Tower component, depicted in the center of FIG. 3.1, represents a suite of fully managed cloud services deployed on AWS to orchestrate and manage the foglight platform. This component leverages AWS-managed services to handle fleet-scale data ingestion and alert processing when anomalies are detected on monitored devices.

MQTT event streams of remote foglight agents are routed through AWS IoT Core and sent to an AWS Timestream database for persistent storage and subsequent analysis. When anomalous behavior is reported from an edge device, foglight Tower can be configured to trigger immediate alerts through the AWS Simple Notification Service (SNS). Real-time visualization of managed fleet device health is provided via AWS-managed Grafana dashboards that seamlessly integrate with time-series data. An example Grafana dashboard the inventors created to visualize the real-time status of edge devices is shown in FIG. 3.4.

foglight Tower's managed services approach provides automatic horizontal scaling to accommodate variable computational loads across large device fleets without requiring manual infrastructure provisioning. This architecture inherits AWS's built-in fail-safes, effectively eliminating the need for a custom backend infrastructure. Fleet management operations scale linearly with device count through IoT Core's native device registry and message routing capabilities, while the time-series database maintains optimized query performance as historical data volumes accumulate. Alert delivery mechanisms support multiple notification channels to facilitate coordinated security incident management via SNS integration.

### 3.4.4.3 Foglight API

The foglight API, shown on the right side of FIG. 3.1, provides enterprise-grade integration capabilities designed to incorporate the foglight platform into existing organizational security infrastructures of companies that manage distributed edge devices. Rather than imposing proprietary tooling, this component prioritizes integration with established enterprise security workflows and incident management procedures that these organizations already have in place.

The API provides multiple integration pathways to accommodate different organizational needs. It subscribes to internal MQTT topics within the platform to receive anomaly alerts and publishes MQTT messages for agent configuration management and mitigation actions. A key innovation is the WebSocket streaming interface that publishes filtered real-time event streams, enabling security operations centers to achieve comprehensive situational awareness of fleet health and security posture as events occur.

For these enterprise integration use cases, OAuth-secured REST APIs enable direct integration into customer-owned Security Information and Event Management (SIEM) systems. These APIs support investigation workflows and automated response capabilities based on alerts generated by calBERT running on hubs. Organizations lacking native API integration capabilities can take advantage of a web application the inventors constructed that provides full platform access without requiring custom development.

### 3.4.4.4 MQTT Messaging Architecture

MQTT serves as the communication protocol across the entire foglight platform, enabling coordinated operations among the Agent, Tower, and API components. This communication is essential for sending anomaly notifications from edge devices to the cloud and for coordinating responses back to the fleet. MQTT was selected due to its lightweight protocol overhead, native publish-subscribe semantics, and robust handling of intermittent network connectivity common in edge deployments. The protocol's built-in quality-of-service (QoS) guarantees ensure reliable delivery of critical security alerts while ensuring efficient use of available network resources.

The MQTT topic hierarchy implements a structured naming convention to support large-scale device management. Edge devices publish health checks and operational status to the device/{device id}/events channels, providing continuous device health metrics and enabling automated monitoring in the Foglight Tower. Configuration management occurs through device/{device id}/monitor topics, where the Tower delivers configuration updates for the foglight Agent. Mitigation commands are sent to edge devices via device/{device id}/cmd channels, enabling remote execution of security responses. Security detection events from all fleet devices aggregate through the centralized device/detector channel, enabling fleet-wide visibility and coordinated incident response, a critical architectural requirement for effective distributed malware detection.

This messaging architecture unifies the three core foglight components into a cohesive platform, enabling seamless coordination between edge-based detection, cloud-based management, and enterprise integration while maintaining the performance and security requirements essential for production anomaly detection systems.

### 3.4.4.5 Detection Results

The main metric used to evaluate online anomaly detection is time-to-detection (TTD). The TTD along with the false positive rate are the most important statistics to analyze in online anomaly detection because anomaly detection must be both quick and correct. The results in the table shown in FIG. 5.3.1 show that most malware can be detected quickly on the router in about one second from initial malware infection. The system call detector performs very well across all malware patterns, which is reasonable since each pattern's footprint is, to some extent, represented in the system call data. The network detector often is able to find network-intensive malware behaviors quicker, which is sensible because this malware generates many packets, leaving a pronounced footprint.

The false positive rate is also kept low at about 1% for both system call and network detection. The inventors attribute this phenomenon to the exponential moving average described above. Although some sentences would be considered anomalous in isolation, the smoothing factor provides a more robust margin of error. This is helpful because the user is not burdened with observations that are slightly anomalous—perhaps due to false positives—but is only alerted when a trend of data is shown to be anomalous. Additionally, the results show that although not every malicious sentence alerts the user, when a real anomaly occurs, it is still detected quickly with a lower false-positive rate.

The first malware the inventors examine is a download. In this case, the system call detector is able to find the malware quickly for the 90% and 95% confidence intervals, while the network detector is able to find the malware much faster for every confidence interval. Since this is a network-intensive malware, the added benefit of using the network detector is made clear by a reduction in TTD.

The traverse malware is evaluated based on system call data because it generates no network traffic. The detection is slightly slower in this case, but on average it can be detected in about a second in the 90% confidence interval and slightly over 1 second in the 95% confidence interval.

The encrypt malware is evaluated using system call data. It is detected slightly quicker than traverse at both the 90% and 95% confidence intervals.

The rename malware was detected even faster than the previous two at the 90% and 95% confidence intervals. Unlike the previous two malware patterns, rename was detected in the 99% confidence interval within 2 seconds.

The compile malware was detected quickly in the 90% confidence interval, but the TTD for both the 95% and 99% confidence intervals increased more dramatically than with the filesystem-focused malware above.

The next three malware are system-intensive and network-intensive and are examined through the lens of both system call and network data. The first is the lateral malware, which is detected faster using system calls. This is reasonable because the malware first looks for passwords and performs other system-related tasks before attempting to make remote connections over the network. The system call detector outperformed the network detector for the 90%, 95%, and 99% confidence intervals by a wide margin.

The combo malware downloads code from git, compiles the code, and then traverses the file tree encrypting/decrypting the files it encounters. Since network activity occurs first, the network detector finds malware faster than the system call detector for every confidence interval by a wide margin.

Lastly, for the APT malware, the system call detector significantly outperforms the network detector for the 90% confidence interval, although for the 95% confidence interval, the network detector is faster. For the 99% confidence interval, the system call detector outperforms the network detector. It is reasonable that the performance for the APT is similar between the two detectors, since the APT is doing both system-intensive work such as walking the file tree of the infected host as well as network-intensive work by exfiltrating the data to a remote host.

### 3.4.4.6 Conclusion

The main contribution of this section 3.4 is a practical online anomaly detection monitoring system that uses an innovative and custom-trained LLM model called calBERT to detect anomalies quickly and alert the user in real-time. the inventors call the complete framework foglight, because computation is focused in the fog as opposed to the cloud. There are three main components to foglight: Foglight Agent, Foglight Tower, and Foglight API.

System calls and network packet data are streamed from a Linux router serving a realistic network ecosystem to a separate device called the hub, which performs model inference using calBERT. calBERT is a custom-trained model using contrastive adversarial learning, which is invaluable for anomaly detection since it needs only benign data to train but generalizes for non-benign (malicious) data observed during inference. the inventors evaluated the model using several common malware patterns by calculating their corresponding time-to-detection, which measures how quickly the anomaly detector found the malware after their initial execution. The resulting device health statistics are sent to the cloud for user monitoring via a Grafana dashboard. The dashboard shows the health of the device over time.

The TTD results show that calBERT is able to detect anomalies within about 1 second. The system call detector performs well across all the malware patterns surveyed, while the network detector outperforms the system call detector for certain network-intensive malware.

### 4.4 On the Added Benefit of Contrastive Adversarial BERT for Defending Home Routers Against Network-Intensive Malware Description

### 4.4.1 Related Work

### 4.4.1.1 Behavioral Malware Detection

Behavioral malware detection seeks to understand and model a device's benign behavior, flagging behavior that deviates from this model as malicious. The benefit of this approach is that no prior knowledge of malware is necessary and only benign data are necessary for model training, which is often readily available, in contrast to realistic and usable malware data. Several shallow machine learning models have been used for anomaly detection, such as one-class SVMs, autoencoders, and random forests.

### 4.4.1.2 Large Language Models for Malware Detection

The recent popularity of large language models (LLMs) has grown significantly as commercial chatbot applications are increasingly used for tasks such as writing and coding. While there has been an extensive amount of research into training these models using natural spoken languages, the research into applying these principles to more specialized languages (e.g., a network-activity language) has not been explored extensively.

However, there has been significant research into harnessing the power of LLMs to boost results in a variety of areas, such as ransomware detection and IoT malware detection using network packet information. The inventors believe this approach differs from the one in section 4.4 in that they collected network data from a router serving a realistic home network ecosystem, and in that the embeddings are generated using a specific network-related language rather than the standard LLM tokenization/vectorization process using pre-trained embeddings. There have also been efforts to detect Android malware using LLMs, which attempts to model semantic dependencies within Android application packages (APKs).

Lastly, there has been recent work on detecting malware on Linux devices using representative device system calls and a range of LLMs, including BERT, GPT-2, and Mistral. This body of work also overlaps with the inventor's studies, although it has some key differences. One is that the earlier work uses pre-trained models with a classification layer on top for model fine-tuning, whereas the inventors' models are trained exclusively on system call or network packet data separately. Additionally, as alluded to, existing models focus on a binary classification task, whereas this work is focused on anomaly detection, as anomaly detection is better suited for zero-day attacks and other stealthy malware mentioned above.

### 4.4.1.3 Contrastive Learning

Contrastive learning has been applied to several domains, such as anomaly detection in graphs and in images. It has also been used recently in conjunction with LLMs for research in the medical field, code authorship, and training LLMs to answer in a certain way to align with a user's intent. These are just a few examples of widely divergent fields that are all harnessing the power of LLMs using contrastive learning.

There are many variants of contrastive loss, such as mean-shifted contrastive loss, as well as triplet loss. Triplet loss is a popular loss function for machine learning models in a wide array of model applications, such as computer vision, and aims to learn meaningful data representations by comparing the distances of the three triplet vectors. The inventors triplet loss framework is similar to an earlier approach that used a triplet mining strategy to align matching and non-matching faces.

### 4.4.2 Technical Approach

### 4.4.2.1 Network Ecosystem

There are two main components in this network ecosystem: the router, which interconnects all devices, and the AWS server that dashboards sensor readings from connected devices. There are six connected devices in the ecosystem connected to the router using three types of common communication protocols: WiFi, Bluetooth Low Energy (BLE), and Zigbee. The ecosystem is shown in more detail in FIG. 4.1 for illustration purposes, while the complete list of devices is shown below.
PurpleAir PA-II air quality sensor (WiFi)
BerryMed pulse oximeter (BLE)
Philips Hue light bulb (Zigbee)
Google Home (WiFi)
A smartphone (WiFi)
A laptop (WiFi)

FIG. 4.2 provides an example of how the sensor data from a few of the devices above are shown on the AWS server for easy user viewing. Each of the sensors shown in the figure first connects to the router using its respective protocol, and then the server runs several programs that get the current sensor readings from the devices and pushes them to a Grafana dashboard using Prometheus. The combination of gateway programs that get the sensor readings and the AWS Grafana server encompasses an IoT ecosystem that the inventors call IoTOwl.

### 4.4.2.2 Malware Patterns

There are several common types of malware used in this disclosure that the inventors call malware patterns. These malware patterns include fundamental malware behaviors that the inventors believe underpin many of the most common malware. Network packet data was collected for 5 minutes for each malware sample separately. This amount of time was sufficient for the malware to leave its behavioral footprint in the packet data.

The first malware is download, which simply downloads code from a git repository for future use. This malware represents an infection landing on a device, such as a router, and trying to download malicious code to run on it.

The second malware is lateral, which tries to find sensitive passwords in places such as/etc/shadow and then attempts to ssh into local hosts on the network. This malware leaves a system call behavior footprint by examining files, as well as a network behavior footprint by using tools like ssh.

The third malware is combo, which, as the name suggests, combines several malware behaviors. These include downloading code from git, compiling C code, and traversing the infected device's file tree and encrypting/decrypting each file. This malware is a more comprehensive example that encompasses a few of the fundamental behaviors of malware: downloading code, compiling code, and conducting reconnaissance on the infected device.

The last malware is the APT, which is a C client/server application that exfiltrates data from an infected host to an attacker's server. It is designed to be stealthy by running and then sleeping for periods of time, as well as using a bandwidth limit to reduce the amount of data sent over the network to try to be more stealthy. In this experiment, the inventors ran the APT for 60 seconds and then let it sleep for 10 seconds before running it again. The bandwidth limit was set to 100 KB/s.

Each of the malware behaviors log the process IDs associated with its functionality. Some PIDs are difficult to collect for extremely short-lived processes, but most can be collected during malware execution. In general, it is possible to isolate the network behavior of malware by associating packets with the PID of each executing malware sample.

4.4.2.3 Network Packet Collection Using eBPF

To collect high-fidelity network telemetry from the router the inventors use the Extended Berkeley Packet Filter (eBPF) subsystem. eBPF enables dynamic instrumentation of the Linux kernel, allowing real-time monitoring of network events directly in kernel space without modifying system binaries or introducing performance bottlenecks typical of userspace collection tools such as tcpdump.

FIG. 4.3 shows the various eBPF attachment points in the kernel's networking stack where individual packet metadata can be extracted during runtime. Because attribution of network activity to user-space processes is a critical requirement for the anomaly detection approach, the inventors target data collection at the socket layer in the kernel. Although lower layers, such as XDP (driver layer) and TC (transport layer), offer more efficient packet capture, they lack the context necessary to associate packets with the processes that send or receive them. The socket layer provides this linkage, enabling the inventors to capture both inbound and outbound traffic along with the process identifiers needed to isolate malware behavior. Such process-level network data are a reliable proxy for a program's expected behavior with respect to network activity, allowing the inventors to build semantically meaningful input sequences for the net2vec model.

### 4.4.2.4 Network Packets as a Language

Like many types of device communication, packet traffic can be reduced to a small set of vocabulary words, each with a distinct meaning. Since all packets have the same structure, the key to differentiating them by their function is the effective bucketing of the data points. For example, IP addresses are often ephemeral and therefore not helpful for training a generalizable model. Similarly, extremely granular values, such as the size of the packet in bytes, results in a sparse vocabulary that is not as conducive to effective model training.

Listing 1, shown in FIG. 5.4.1, is a visualization of the raw data each packet contains.

Many of the fields are preprocessed from the data, leaving only the proto, sip, sport, dip, dport, sz, and dir fields which are then bucketed into more general groupings. The IP addresses are bucketed into the following groupings, which defaults to “Public” if no matches are found, as shown in FIG. 5.4.2.

The ports are bucketed into three groups using the normal Linux groupings. Ports from 0 to 1023 are “WellKnown,” ports from 1024 to 49151 are “Registered,” and ports from 49152 to 65535 are “Dynamic”. The other fields retained from the packets are bucketed into the following groups shown in FIG. 5.4.3.

After the data are sufficiently generalized, the benign data are used to train a Word2vec model provided by the Gensim package, which the inventors call net2vec. Using the resulting embeddings, the BERT model is then trained using a contrastive adversarial approach. The triplets are created by looping through the training data. For each sentence in the data, the current sentence is the anchor example, the next sequential sentence is the positive example, and a randomly selected sentence whose index is greater than the index of the positive example is chosen to be the negative sample. The negative sample is then mutated by randomly selecting a new valid field for each field in a word. For example, instead of the protocol being TCP, it may be changed to be UDP. A more concrete example is provided in FIG. 4.5.

### 4.4.2.5 Contrastive Adversarial BERT

Our BERT model uses the BertModel class available off-the-shelf from transformers library in PyTorch. Wrapped around the core models is a fully connected layer to transform the vector dimensionality from net2vec's 64-length vectors to BERT's 768-length vectors, as well as a LayerNorm, the positional embeddings, and a Dropout layer after the BertModel layer. The outputs of the Dropout (p=0.2) layer are then pooled using mean pooling and normalized. The cosine similarities of the normalized anchors and positives, as well as anchors and negatives, are then passed into the custom cosine similarity-based loss function, defined in Equation 4.1, where the margin is set to 0.5.

$$L = E [ max ( 0 , - cos ( a , p ) + cos ( a , n ) + margin ) ] \qquad EQ . 4.1$$

FIG. 4.6 shows the model architecture in more detail, including the data pre-processing steps of generalizing the data and training net2vec embeddings for each distinct packet

### 4.4.2.6 Model Evaluation

After the model is trained, the evaluation data are passed through the model and the resulting data are used to obtain pairwise cosine similarities between the BERT embeddings. An example depicting cosine similarities is shown in FIG. 4.7. As shown in the figure, three benign datasets are used in the evaluation of each malware dataset. The reason for this is that the inventors want to gauge how generalizable the approach is, using three distinct, separately-collected benign datasets to ensure that the model is not just learning the patterns of one specific benign dataset. As this and the other examples show, there is substantial separation between the malware embeddings, shown on the left of the aforementioned figure, and the several benign embeddings, which are clustered on the right side of the figure.

Upon obtaining the pairwise cosine similarities, a Gaussian Kernel Density Estimator (KDE), available from SciPy, is fit using the concatenation of the three benign datasets. The model is then evaluated by the percentage of malware captured in the 90% confidence interval, 95% confidence interval, and the 99% confidence interval of the KDE, respectively. The p-values for the datasets are calculated using the built-in integrate_box_1d function, which integrates from −∞ to each cosine similarity in each dataset. After obtaining the p-values, the inventors predict if each sample is benign or malware by checking if its p-value is less than a given significance level a, where α∈{0.1, 0.05, 0.01} corresponding to the left tail of the distribution for 90%, 95% and 99% confidence intervals, respectively.

### 4.4.3 Experimental Results

Overall, the experimental results show that the network based anomaly detection model performs well for network focused malware, and substantially improves on the results obtained by the system calls for three out of the four cases. The results are summarized in the table in FIG. 5.4.4.

In the first case, the result for the system call anomaly detector for the download malware is 50%, whereas the result for the network anomaly detector is 100% for the same malware sample, the inventors attribute this increase to the fact that while there are some system calls related to downloading code from git, their behavioral footprint is much less pronounced than the many packets flowing to download all of the code from a “Public” IP address.

In the second case, the best system call result for the lateral malware sample is quite close to the result using network traffic. This similarity is attributed to the fact that this malware sample has a larger system call footprint because it is exploring files and performing more system focused tasks than the other three malware examined here. In the third case, the best system call result for the combo malware sample is 1.79%, while the corresponding network result is 100%, another obvious improvement.

In the final case, the best system call result for the APT malware sample is 0.9%, while the network result is 100%, a clear improvement

### 4.4.4 Summary and Conclusions

This disclosure focuses on increasing malware detection efficacy on routers by examining network-intensive malware through the lens of a custom-designed network packet language and embedding space and using these data to train a BERT-based anomaly detector. The network packets were collected from a router that services a realistic home network consisting of several devices using a variety of communication protocols. These devices include a WiFi-enabled laptop and phone, and more obscure but emerging technologies like a Zigbee-based Hue lightbulb. Once the packets are collected from the router, they are generalized such that useful fields like protocol and size are bucketed into larger groupings and not useful fields for the task like namespaces are discarded.

The generalized packets are then embedded into 64length vectors using a Word2vec-like model that the inventors call net2vec, which provide static contextual embeddings to feed into the contrastive adversarial BERT model. After creating vector embeddings for each packet “word” in the observed vocabulary, the inventors process the data into sentences of length 50, which are then split into triplets. Each triplet contains an anchor, a positive example (similar to the anchor), and a negative example (designed to be dissimilar to the anchor). For each sentence in the data, the anchor is the first sentence, the positive example is the next sequential sentence after each anchor, and the negative example is randomly chosen from sentences not seen up to the index of the positive example. The random negative is then mutated by changing each token of each word with a probability of 50%.

Using these triplets and the custom triplet loss function defined in Equation 4.1, the BERT model learns to keep the similarity of the anchor and the positive example high, while attempting to reduce the similarity between the anchor and the negative example. The BERT model is then evaluated by first calculating the pairwise cosine similarities between a benign dataset and two other benign datasets as well as between the same benign dataset and the malware dataset, which includes only packets associated with PIDs generated from malware execution. The cosine similarities of the benign datasets are then used to fit a Gaussian kernel density estimator, which is used to integrate over the distribution of the malware to calculate the p-values. the inventors then use three confidence intervals, 90%, 95%, and 99%, to predict whether malware are in the benign distribution or not.

The results show that using this method of network anomaly detection in conjunction with other representative behavior data is a good way to detect a wide variety of malware. In particular, both the system call framework and the network packet framework worked well for both the 90% and 95% confidence intervals, but the results are noticeably different for the 99% confidence interval for network-focused malware. The most significant gains in performance for the network detector over the system call detector are with the APT malware and the combo malware. The increase in the performance for the APT is understandable because its main focus is to traverse the filesystem and exfiltrate data, and as such there are many of the exact same packets in the data from its exfiltration behavior. The network behavioral footprint of combo is similar to that of download, because both malware start by downloading code from the Internet, which yields an obviously anomalous footprint because this is a rare event for a router. Although combo subsequently performs more system-focused tasks such as compiling the downloaded code, the downloading behavior provides enough network traffic to trigger an anomaly.

Although system calls indirectly capture network activity, the malicious signal can be difficult to differentiate because of the added noise in system call data from many processes requesting resources, especially if the malware are not system-intensive. In such cases, using network packet data is better than using system call data because the malicious signal is much clearer for network-intensive malware. In contrast, for system-focused malware patterns like compiling code or encrypting files, system calls or other system-related data is necessary.

### Description of Certain Terms Used Herein

Transformer-based encoder: As used herein, the term “transformer-based encoder” includes, but is not limited to, BERT, ROBERTa, DistilBERT, ALBERT, GPT, or any model implementing an attention-based architecture configured to generate embeddings or perform anomaly detection.

Embedding model: The term “embedding model” includes sys2vec, net2vec, Word2vec, GloVe, graph embeddings, or any representation learning model trained on sequences of system call data or network packet data.

Anomaly detection model: The term “anomaly detection model” includes isolation forests, autoencoders, support vector machines, random forests, or any machine learning model configured to identify deviations from benign behavioral profiles.

Similarity metric: The term “similarity metric” includes cosine similarity, Euclidean distance, Mahalanobis distance, or other distance functions used to compare embeddings.

Dashboard or user-facing interface: References to specific dashboards (e.g., Grafana) are illustrative only and include any visualization or reporting interface configured to display anomaly detection results.

Malware patterns: Specific examples of malware patterns (download, traverse, encrypt, lateral, APT, etc.) are illustrative only and are not limiting, as other malware patterns and variants may also be detected by the disclosed systems and methods.

While the invention has been described with reference to the embodiments above, a person of ordinary skill in the art would understand that various changes or modifications may be made thereto without departing from the scope of the claims.

We claim:

1. A computer-implemented method for detecting anomalous behavior on a router, the method comprising:
collecting system call data generated by processes executing on the router;
transforming the system call data into vector embeddings using an embedding model trained on system call sequences;
providing the vector embeddings to a transformer-based encoder;
training the transformer-based encoder using a contrastive learning framework comprising an anchor sample, a positive sample, and a negative sample derived from benign behavioral data; and
detecting anomalous behavior by determining whether subsequent system call data processed by the trained transformer-based encoder deviates from a benign behavioral profile.

2. The method of claim 1, wherein the embedding model comprises a sys2vec model trained on system call sequences.

3. The method of claim 1, wherein the transformer-based encoder comprises a BERT model.

4. The method of claim 1, wherein the contrastive learning framework applies a triplet loss function based on a similarity metric selected from cosine similarity, Euclidean distance, or Mahalanobis distance.

5. The method of claim 1, wherein the anchor sample is a first sentence of system calls, the positive sample is a next sequential sentence, and the negative sample is a randomly selected sentence.

6. The method of claim 5, further comprising mutating the negative sample by replacing fields with logically consistent alternatives to increase model robustness.

7. The method of claim 1, further comprising fitting an anomaly detection model on embeddings generated from benign behavioral data and classifying system call data associated with malware execution as anomalous.

8. The method of claim 7, wherein the anomaly detection model comprises an isolation forest.

9. The method of claim 1, wherein the transformer-based encoder is pre-trained as a masked language model on system call embeddings.

10. The method of claim 1, wherein detecting anomalous behavior comprises identifying malware patterns including at least one of download, traverse, encrypt, rename, compile, combo, lateral, or advanced persistent threat malware.

11. A system for anomaly detection in a router environment, the system comprising:
a router configured to execute processes and generate system call data and network packet data;
an extended Berkeley Packet Filter (eBPF) sensor suite configured to collect the system call data and the network packet data;
a hub device communicatively coupled to the router; and
a transformer-based encoder trained with contrastive adversarial learning, executed on the hub device, the transformer-based encoder configured to detect anomalous behavior from the system call data and the network packet data.

12. The system of claim 11, wherein the transformer-based encoder comprises a calBERT model trained with contrastive adversarial learning.

13. The system of claim 11, wherein the router and hub device are integrated in a foglight framework comprising an Agent, a Tower, and an Application Programming Interface.

14. The system of claim 11, wherein the network packet data is preprocessed by bucketizing Internet Protocol addresses and port numbers into categories including Public, Private, Loopback, LinkLocal, Multicast, Documentation, SourcePortWellKnown, SourcePortRegistered, or SourcePortDynamic.

15. The system of claim 11, wherein the network packet data is transformed into net2vec embeddings.

16. The system of claim 15, wherein the transformer-based encoder is trained on the net2vec embeddings using contrastive adversarial learning.

17. The system of claim 15, wherein anomaly detection results from sys2vec embeddings of system calls and net2vec embeddings of network packets are combined to detect both system-focused malware and network-intensive malware.

18. The system of claim 11, wherein the anomalous behavior comprises downloading code, compiling code, traversing a file system, encrypting data, decrypting data, or exfiltrating data.

19. The system of claim 11, wherein the transformer-based encoder outputs anomaly detection results to a user-facing interface.

20. The system of claim 11, wherein the transformer-based encoder is trained using a triplet loss framework in which the anchor sample comprises a sentence of benign behavior, the positive sample comprises a next sequential benign sentence, and the negative sample comprises a mutated random sentence.
